(19) United States
(12) Patent Application Publication
(10) Pub. No.: US 2025/0181996 A1
(43) Pub. Date: Jun. 5, 2025

(54) VACATION PACKAGING CONFIGURATOR

(71) Applicant: WWSG TRAVEL, INC. D/B/A VACAYOU, Treasure Island, FL (US)

(72) Inventor: Muirgheal Montecalvo, Treasure Island, FL (US)

(21) Appl. No.: 19/046,743

(22) Filed: Feb. 6, 2025

Related U.S. Application Data
(63) Continuation-in-part of application No. 18/356,728, filed on Jul. 21, 2023, now abandoned.
(60) Provisional application No. 63/394,666, filed on Aug. 3, 2022.

(51) Int. Cl. G06Q 10/02; G06Q 30/0201; G06Q 30/0283; G06Q 50/14

(52) U.S. Cl. CPC G06Q 10/02; G06Q 30/0206; G06Q 30/0283; G06Q 50/14; G06Q 2220/00

(57) ABSTRACT

Described herein relates to a system of and method for optimizing structuring, booking, and/or viewing at least one travel itinerary, vacation package, and/or property package in real-time. The vacation package configurator system may automatically search and/or cache vacation topics, such as at least one wellness experiences and/or at least one property (e.g., a hotel). Additionally, the vacation package configurator may automatically combine the two aspects (e.g., a third-party jet ski tour and a king size bed room within a selected property) into bookable and/or dynamic packages. Accordingly, the vacation packages may be structured such that the vacation package configurator system may automatically verify the real-time pricing and/or availability of the selected vacation package and/or property package within the booking process. As such, in embodiments, a user may be enabled to make real-time bookings of the vacation package.

### CROSS-REFERENCE TO RELATED APPLICATIONS

This Nonprovisional Patent application is a Continuation-in-Part of and claims the benefit of and priority to U.S. Nonprovisional patent application Ser. No. 18/356,728, entitled “VACATION PACKAGING CONFIGURATOR”, filed Jul. 21, 2023 by the same inventor(s), which claims the benefit of and priority to U.S. Provisional Application No. 63/394,666 entitled “VACATION PACKAGING CONFIGURATOR” filed Aug. 3, 2022 by the same inventor(s), all of which is incorporated herein by reference, in its entirety, for all purposes.

### BACKGROUND OF THE INVENTION

### 1. Field of the Invention

This invention relates, generally, to an integrated platform (e.g., system) for travel itinerary. More specifically, it relates to a system and method for optimizing structuring, booking, and/or viewing at least one travel itinerary (e.g., trip), at least one vacation package (e.g., vacation), and/or at least one property package in real-time.

### 2. Brief Description of the Prior Art

Usually, planning, booking, and viewing a travel itinerary can be quite a time-intensive process. A user typically must rely on multiple websites and/or platforms to plan or book various trip components, such as hotels, airfare, rental cars, golf outings, and spa retreats. Users will usually have to look through the individual company websites and enter their search, personal, and payment information repeatedly before they can officially book the trip. Accordingly, it can be increasingly difficult for a user to keep track of the entire travel itinerary, due to having to know log-in and personal information to view the entire trip.

Additionally, many times several key aspects of the user's trip may not be available during the certain range of dates that a user was interested in travelling. The user may book the hotel or airfare without first realizing that the golf course no longer has the times available for their trip. While users in the past used travel agencies to book each aspect of the travel itinerary, the travel agencies may be extremely costly and force the user to remove certain items or events from the trip in order to cover the travel agency costs.

Recent advances in travel itinerary software have enabled use of API, allowing the user to use an integrated single platform on a computing device to select aspects uniformly and succinctly for a vacation, while the travel itinerary software interacts with the third-party corporation websites and/or platforms. However, the currently known travel itinerary software using this technology—such as the one disclosed in U.S. Pub. No. 2021/0326780 (Published Oct. 21, 2021)—require that the user to select certain parameters, such as price range, for a predetermined date in order to book the trip. Accordingly, applications of such travel itinerary software are limited to certain items and events that are available at that time, and at that specified price range. Thus, currently known travel itinerary software is incapable of selecting every item and event the user desires, at the lowest available price, with a range of available dates for the desired package.

Accordingly, what is needed is an easy-to use, succinct, vacation packaging configurator which allows a user to include all desired aspects of the vacation package at the lowest available price. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need for an easy-to use, succinct, vacation packaging configurator which allows a user to include all desired aspects of the vacation package at the lowest available price is now met by a new, useful, and/or nonobvious invention.

An aspect of the present disclosure pertains to a system for structuring vacation packages and/or booking vacation packages. In an embodiment, the system may comprise a processor configured to execute machine-readable instructions stored on a non-transitory computer-readable medium for vacation package structuring and booking. The system may further include a vacation packaging engine executed by the processor, such that the vacation packaging engine may be communicatively coupled to at least one preference profile module, at least one real-time package availability and/or pricing module, and at least one booking engine. Additionally, the system may incorporate a popup packaging widget module communicatively coupled to the vacation packaging engine, such that the popup packaging widget module may retrieve at least one vacation package generated by the vacation packaging engine based on at least one user-selected vacation topic and display the at least one vacation package via at least one user interface communicatively coupled to the processor. Moreover, the system may include an opaque pricing module executed by the processor, such that the opaque pricing module may generate a bundled vacation package price by concealing at least one individual pricing component, such that the bundled vacation package price may dynamically adjust based on a revenue management rule, a user engagement metric and/or and a demand-based pricing variable. Furthermore, the system may include a multifactorial AI decision support algorithm, executed by the processor, such that the multifactorial AI decision support algorithm may analyze at least one user interaction to modify vacation package recommendations in real time.

In some embodiments, the system may further comprise a blockchain-based transaction module, wherein the blockchain-based transaction module may store at least one booking confirmation and at least one pricing adjustment in a decentralized ledger, ensuring secure recordkeeping and transaction verification. In these other embodiments, the blockchain-based transaction module may be configured to record all transaction details to a decentralized ledger using at least one consensus validation mechanism. In this manner, the blockchain-based transaction module may execute at least one smart contract automation process to ensure automatic refund processing in case of pricing inconsistencies.

In some embodiments, the system may further comprise a real-time package availability and/or pricing module, wherein the real-time package availability and/or pricing module may retrieve Availability, Rates, and Inventory (ARI) data and verify the real-time pricing of at least one vacation package component prior to booking.

In some embodiments, the system may further comprise an Application Programming Interface (API) configured to facilitate external communication between the vacation packaging engine and at least one third-party service provider, ensuring real-time data synchronization. As such, the system may further comprise a booking engine, such that the booking engine may be configured to finalize the at least one transaction of the vacation package based on real-time pricing verification and/or update an acceptance module to confirm the successful booking.

In some embodiments, the popup packaging widget module may retrieve at least one vacation topic from the vacation packaging engine via the API-based data exchange. In these other embodiments, the popup packaging widget module may also dynamically update vacation package recommendations using the AI-based personalization engine trained on at least one behavioral clustering algorithm. In some embodiments, the AI-based personalization engine may continuously refine at least one user preference model using deep learning-based predictive analytics. Accordingly, the AI-based personalization engine may integrate collaborative filtering algorithms to identify vacation packages preferred by similar user segments.

Another aspect of the present disclosure pertains to a method for structuring at least one vacation package. In an embodiment, the method may comprise the step of retrieving at least one vacation topic via a vacation topics import engine, executed by a processor of a vacation packaging configurator, such that the vacation topics import engine may be executed by a processor communicatively coupled to a vacation packaging configurator. Additionally, in this embodiment, the method may further include the step of, generating at least one vacation package recommendation from the at least one retrieved vacation topic using at least one multifactorial AI decision support algorithm, executed by the processor, such that the at least one multifactorial AI decision support algorithm may execute at least one machine-learning-based engagement model to analyze at least one preference profile of the at least one user in conjunction with the at least one retrieved vacation topic. Moreover, the method may further comprise the step of, applying an opaque pricing module of the vacation packaging configurator to determine a bundled vacation package price, such that the opaque pricing module may conceal at least one individual pricing component. Furthermore, the method may include dynamically modifying at least one vacation package component based on real-time package availability and/or pricing module data, such that the real-time package availability and/or pricing module may retrieve at least one ARI data set and/or cross-reference an API from at least one third-party service provider, via the processor.

In some embodiments, the method may further comprise the step of, finalizing a structured vacation package and transmitting at least one structured vacation package confirmation via at least one acceptance module. In addition, the method may further comprise the step of, storing a vacation package structuring record in a blockchain-based transaction module, such that the blockchain-based transaction module may ensure pricing integrity and transaction immutability.

In some embodiments, the popup packaging widget module may optimize upsell recommendations by utilizing at least one predictive conversion model based on past user interactions.

Furthermore, an additional aspect of the present disclosure pertains to a method for booking at least one vacation package. In an embodiment the method may comprise the step of, receiving at least one vacation package selection via a popup packaging widget module executed on a processor communicatively coupled to a vacation packaging configurator. In this manner, the method may further include the step of, retrieving real-time ARI data via a real-time package availability and/or pricing module of the vacation packaging configurator, such that the real-time package availability and/or pricing module may confirm the availability and/or cost of at least one vacation package component. Additionally, the method may further comprise the step of, comparing the vacation package price with the real-time ARI data retrieved by the real-time package availability and/or pricing module to determine whether the stated vacation package price is consistent with the latest real-time pricing data. Furthermore, the method may also include the step of, dynamically modifying the bundled vacation package price via an opaque pricing module if the stated vacation package price does not match the real-time ARI data, such that the opaque pricing module may adjust the price using at least one multifactorial AI decision support algorithm to recalculate the bundled package rate based on predefined revenue management rules. Moreover, the method may also comprise the step of, transmitting at least one structured travel itinerary to at least one user interface communicatively coupled to the vacation packaging configurator, such that the structured travel itinerary may include real-time pricing adjustments and/or automated refund processing data if a pricing inconsistency is detected.

In some embodiments, the method may further comprise the step of, processing the vacation package transaction using a blockchain-based transaction module communicatively coupled to the vacation packaging configurator, such that the blockchain-based transaction module may execute at least one smart contract validation mechanism to confirm at least one booking term and ensure transaction integrity. In some embodiments, the method may further comprise the step of, finalizing the at least one vacation package booking via a booking engine of the vacation packaging configurator, such that the booking engine may update an acceptance module to confirm the booking.

In some embodiments, the at least one multifactorial AI decision support algorithm may optimize vacation package suggestions using at least one reinforcement learning model trained on past user engagement metrics. In these other embodiments, the opaque pricing module may also retrieve real-time competitor pricing data from at least one API-based pricing analysis service to ensure competitive rates associated with the vacation package.

Moreover, when booking the vacation package for the user, the vacation packaging configurator system may compare the real-time availability and price of the vacation package with the originally cached availability and price, via Availability, Rates, and Inventory (hereinafter “ARI”) and/or Application Programming Interface (hereinafter “API”) programming. Furthermore, if the real-time availability and price of the vacation package is not substantially similar to the originally cached availability and price of the vacation package, the vacation packaging configurator system may send a notification to the user of the price and availability change. Additionally, in some embodiments, the vacation packaging configurator system may automatically input the personal and payment information of the user to optimize the booking process of the vacation package for the user.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a vacation packaging configurator system integrated with internal and external data sources, creating both standard vacation packages and user-specific vacation packages, according to an embodiment of the present disclosure.

FIG. 2 is a vacation packaging configurator system integrated with internal and external data sources, creating both standard vacation packages and user-specific vacation packages with real-time ARI and API verification and at least one multi-factorial AI decision support algorithm, according to an embodiment of the present disclosure.

FIG. 3 is a flow diagram of modules for a vacation packaging configurator system, according to an embodiment of the present disclosure.

FIG. 4A depicts an exemplary configuration of a hotel preference profile of a vacation packaging configurator system, according to an embodiment of the present disclosure.

FIG. 4B depicts an exemplary configuration of a selection of a hotel preference profile of a vacation packaging configurator system by a user, according to an embodiment of the present disclosure.

FIG. 4C depicts an exemplary configuration of a hotel output of a vacation packaging configurator system based on a selection inputted by a user, according to an embodiment of the present disclosure.

FIG. 4D depicts an exemplary configuration of a selected property package of a vacation packaging configurator system, according to an embodiment of the present disclosure.

FIG. 4E depicts an exemplary configuration of a room selection of a selected vacation package of a vacation packaging configurator system, according to an embodiment of the present disclosure.

FIG. 4F depicts an exemplary configuration of a traveler information capture of a selected property package of a vacation packaging configurator system, according to an embodiment of the present disclosure.

FIG. 4G depicts an exemplary configuration of a payment capture of a selected property package of a vacation packaging configurator system, according to an embodiment of the present disclosure.

FIG. 4H depicts an exemplary configuration of a booking engine of a selected property package on a vacation packaging configurator system, according to an embodiment of the present disclosure.

FIG. 5A depicts an exemplary configuration of a vacation package preference profile of a vacation packaging configurator system, according to an embodiment of the present disclosure.

FIG. 5B depicts an exemplary configuration of a selection of a vacation package preference profile of a vacation packaging configurator system by a user, according to an embodiment of the present disclosure.

FIG. 5C depicts an exemplary configuration of a vacation package output of a vacation packaging configurator system based on a selection inputted by a user, according to an embodiment of the present disclosure.

FIG. 5D depicts an exemplary configuration of a selected vacation package of a vacation packaging configurator system, according to an embodiment of the present disclosure.

FIG. 5E depicts an exemplary configuration of a room selection of a selected vacation package of a vacation packaging configurator system, according to an embodiment of the present disclosure.

FIG. 5F depicts an exemplary configuration of a traveler information capture of a selected vacation package of a vacation packaging configurator system, according to an embodiment of the present disclosure.

FIG. 5G depicts an exemplary configuration of a payment capture of a selected vacation package of a vacation packaging configurator system, according to an embodiment of the present disclosure.

FIG. 5H depicts an exemplary configuration of a booking engine of a selected vacation package on a vacation packaging configurator system, according to an embodiment of the present disclosure.

FIG. 6A depicts an exemplary configuration of a guest button of a customizable module of a vacation packaging configurator system fora selected vacation package and/or a selected property package, according to an embodiment of the present disclosure.

FIG. 6B depicts an exemplary configuration of a guest button of a customizable module of a vacation packaging configurator system for a selected vacation package and/or a selected property package allowing a user and/or at least one guest to select and/or assign at least one room and/or at least one alternative room to the user and/or the at least one guest, according to an embodiment of the present disclosure.

FIG. 6C depicts an exemplary configuration of a service button of a customizable module of a vacation packaging configurator system for a selected vacation package and/or a selected property package, according to an embodiment of the present disclosure.

FIG. 6D depicts an exemplary configuration of a service button of a customizable module of a vacation packaging configurator system for a selected vacation package and/or a selected property package, allowing a user and/or at least one guest to select and/or assign at least one additional add-on service and/or at least one alternative service, according to an embodiment of the present disclosure.

FIG. 6E depicts an exemplary configuration of an activities button of a customizable module of a vacation packaging configurator system for a selected vacation package and/or a selected property package, according to an embodiment of the present disclosure.

FIG. 6F depicts an exemplary configuration of a customizable module confirmation of a vacation packaging configurator system for a selected vacation package and/or a selected property package, according to an embodiment of the present disclosure.

FIG. 7 is an exemplary process flow diagram depicting a method for digitally booking a vacation package on a computing device and/or providing real-time availability and/or prices in order to aid a user's vacation booking performance, according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention. Elements/components shown in diagrams are illustrative of exemplary embodiments of the disclosure and are meant to avoid obscuring the disclosure. Any headings, used herein, are for organizational purposes only and shall not be used to limit the scope of the description or the claims. Furthermore, the use of certain terms in various places in the specification, described herein, are for illustration and should not be construed as limiting.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

The computing device readable medium described in the claims below may be a computing device readable signal medium or a computing device readable storage medium. A computing device readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computing device readable storage medium would include the following: an electrical connection having one or more wires, a portable computing device diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computing device readable storage medium may be any tangible medium that can contain or store a program for use by or in connection with an instruction execution system, apparatus, or device.

A computing device readable signal medium may include a propagated data signal with computing device readable program PIN embodied therein, for example, in baseband or as part of a carrier wave. Such a propagated signal may take any of a variety of forms, including, but not limited to, electro-magnetic, optical, or any suitable combination thereof. A computing device readable signal medium may be any computing device readable medium that is not a computing device readable storage medium and that can communicate, propagate, or transport a program for use by or in connection with an instruction execution system, apparatus, or device.

Program PIN embodied on a computing device readable medium may be transmitted using any appropriate medium, including but not limited to wireless, wire-line, optical fiber cable, radio frequency, etc., or any suitable combination of the foregoing. Computing device program PIN for carrying out operations for aspects of the present invention may be written in any combination of one or more programming languages, including an object oriented programming language such as Java, C#, C++or the like and conventional procedural programming languages, such as the “C” programming language or similar programming languages.

Aspects of the present invention are described below with reference to flowchart illustrations and/or block diagrams of methods, apparatus (systems) and computing device program products according to embodiments of the invention. It will be understood that each block of the flowchart illustrations and/or block diagrams, and combinations of blocks in the flowchart illustrations and/or block diagrams, can be implemented by computing device program instructions. These computing device program instructions may be provided to a processor of a general purpose computing device, special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computing device program instructions may also be stored in a computing device readable medium that can direct a computing device, other programmable data processing apparatus, or other devices to function in a particular manner, such that the instructions stored in the computing device readable medium produce an article of manufacture including instructions which implement the function/act specified in the flowchart and/or block diagram block or blocks.

The computing device program instructions may also be loaded onto a computing device, other programmable data processing apparatus, or other devices to cause a series of operational steps to be performed on the computing device, other programmable apparatus or other devices to produce a computing device implemented process such that the instructions which execute on the computer or other programmable apparatus provide processes for implementing the functions/acts specified in the flowchart and/or block diagram block or blocks.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

As used herein, the term “Acceptance Module” generally refers to a component within the vacation packaging configurator that finalizes and confirms vacation package bookings. This module can receive input from the booking engine, verifying the real-time pricing and availability of selected vacation package components. Additionally, the acceptance module can generate confirmation records, send booking details to third-party service providers, and/or ensure that reservation details remain immutable unless canceled and/or modified by an authorized entity. The acceptance module may also store booking history, allowing users to retrieve, manage, and/or update their confirmed reservations within a user interface.

As used herein, the term “AI-Based Personalization Engine” generally refers to a system component that utilizes machine-learning algorithms to analyze user behavior, preferences, and historical booking data to generate personalized vacation package recommendations. The AI-based personalization engine can continuously refine user preference models using deep learning-based predictive analytics. Additionally, this engine can integrate collaborative filtering algorithms to identify vacation packages preferred by similar user segments. The AI-based personalization engine may dynamically adjust vacation package recommendations in real-time based on user engagement, browsing history, and/or stated preferences.

As used herein, the term “Application Programming Interface” (hereinafter “API”) generally refers to any programming or software intermediary that allows an application to communicate with a third-party application. For ease of reference, the exemplary embodiment, described herein, refers to a programming which communicates with hotel, airfare, golf, spa, and rental car applications, but this description should not be interpreted as exclusionary of other types of third-party applications.

As used herein, the term “API-driven synchronization module” generally refers to a programming component that facilitates real-time communication between the vacation packaging configurator and third-party service providers. The API-driven synchronization module can retrieve and update vacation package data, such as availability, rates, and inventory (ARI), from external systems. Additionally, this module ensures that real-time data synchronization occurs seamlessly, preventing discrepancies in pricing or availability. The API-driven synchronization module may also support automated error handling to resolve conflicts between cached pricing and/or live system data.

As used herein, the term “Availability, Rates, and Inventory (hereinafter “ARI”)” generally refers to any programming which controls pricing, availability, and inventory, and provides constraints on how these can be combined. For ease of reference, the exemplary embodiment, described herein, employs the ARI for vacation topics, but this description should not be interpreted as exclusionary of other types of ARI programming.

As used herein, the term “Blockchain-Based Transaction Module” generally refers to a system component that records, verifies, and secures vacation package bookings and pricing adjustments using a decentralized ledger. This module can execute smart contract automation to ensure transparent and tamper-proof financial transactions. Additionally, the blockchain-based transaction module may facilitate automated refund processing in case of pricing inconsistencies or and/or conflicts. The module may integrate with consensus validation mechanisms to verify the authenticity of booking transactions before finalization.

As used herein, the term “Booking Engine” generally refers to a software module responsible for processing and finalizing vacation package reservations within the vacation packaging configurator. The booking engine can retrieve real-time availability and pricing information before completing a transaction. Additionally, it may interact with external APIs to confirm bookings with third-party service providers, ensuring seamless integration with hotels, golf resorts, and wellness experience providers. The booking engine may also store structured travel itineraries and/or issue booking confirmations via an acceptance module.

As used herein, the term “Communicatively Coupled” generally refers to any coupling mechanism configured to exchange information (e.g., at least one electrical signal) using methods and devices known in the art. Non-limiting examples of communicatively coupling may include Wi-Fi, Bluetooth, wired connections, wireless connection, quantum, and/or magnets. For ease of reference, the exemplary embodiment described herein refers to Wi-Fi and/or Bluetooth, but this description should not be interpreted as exclusionary of other electrical coupling mechanisms.

As used herein, the term “Dynamic Package Adjustment” generally refers to a system functionality that modifies vacation package selections based on real-time availability updates. If a selected package component becomes unavailable before checkout, the system may provide alternative options to the user. Additionally, dynamic package adjustment can optimize vacation package itineraries by suggesting alternative accommodations, activities, or pricing structures based on AI-driven recommendations. The functionality may be executed through a popup packaging widget that presents alternative selections to users before finalizing a booking.

As used herein term “Management Rule” generally refers to a predefined set of conditions, parameters, and/or algorithms applied to regulate, optimize, and/or control various aspects of vacation package structuring, pricing, availability, and/or booking processes. These rules may be executed to influence pricing adjustments, real-time inventory updates, user engagement-based modifications, and/or automated package customizations. Management rules may be dynamically applied based on revenue optimization strategies, service provider constraints, AI-driven personalization models, and user preference data. Additionally, these rules may interact with external systems such as Availability, Rates, and Inventory (ARI) modules, Application Programming Interfaces (APIs), and/or blockchain-based transaction verification mechanisms to ensure accurate, automated, and/or optimized vacation package execution.

As used herein, the term “Multifactorial AI Decision Support Algorithm” generally refers to an artificial intelligence-driven computational model that analyzes multiple user engagement metrics to optimize vacation package structuring and booking processes. This algorithm may consider factors such as historical booking data, demand fluctuations, pricing trends, and/or user preferences to generate optimized vacation package recommendations. Additionally, the multifactorial AI decision support algorithm may dynamically adjust pricing models, recommend alternative itinerary options, and/or ensure personalized vacation package offerings. The algorithm may also integrate reinforcement learning models to continuously refine travel recommendations over time.

As used herein, the term “Opaque Pricing Module” generally refers to a pricing mechanism within the vacation packaging configurator that conceals individual component costs while presenting users with a bundled vacation package price. This module can dynamically adjust pricing based on revenue management rules, demand-based pricing variables, and/or user engagement metrics. Additionally, the opaque pricing module may prevent users from reverse-engineering package pricing, ensuring that bundled vacation deals remain exclusive to the platform. The module may integrate with AI-driven market sensitivity simulations to optimize bundled pricing strategies.

As used herein, the term “Popup Packaging Widget” generally refers to a real-time user interface clement within the vacation packaging configurator that dynamically presents vacation package recommendations based on user behavior. This widget may retrieve vacation package data from an API-based data exchange and display relevant package options within a user's booking journey. Additionally, the popup packaging widget may integrate with AI-driven behavioral triggers to ensure optimized package presentation. The widget may support dynamic package adjustment by offering alternative booking options if a selected component is unavailable.

As used herein, the term “Preference Profile Module” generally refers to a system component that collects and processes user preferences to generate tailored vacation package recommendations. The preference profile module can store user-defined parameters such as preferred travel dates, destination types, budget constraints, and activity interests. Additionally, this module may integrate with an AI-based personalization engine to refine vacation package selections based on past user behavior. The preference profile module may dynamically update based on real-time browsing activity, ensuring that vacation package suggestions remain contextually relevant.

As used herein, the term “Pricing Validation Module” generally refers to a system component that verifies vacation package prices against real-time ARI data before finalizing a transaction. This module can compare cached pricing data with live system updates to ensure that users receive the most accurate cost estimates. Additionally, the pricing validation module may trigger automatic pricing adjustments if discrepancies are detected between the stated vacation package price and the latest market rate. The module may integrate with a blockchain-based transaction system to ensure immutable recordkeeping of pricing modifications.

As used herein, the term “Real-Time Package Availability and/or Pricing Module” generally refers to a computational system component that retrieves live availability and pricing data for vacation package components. This module may ensure that all displayed package options reflect up-to-date inventory status and market pricing. Additionally, it may synchronize with external APIs to prevent overbooking or incorrect pricing calculations. The real-time package availability and pricing module may integrate predictive analytics to forecast demand trends and/or optimize availability suggestions.

As used herein, the term “Reinforcement Learning Model” generally refers to a subset of machine-learning algorithms used within the vacation packaging configurator to continuously refine vacation package recommendations based on user interactions. This model can analyze historical booking patterns, real-time engagement data, and/or seasonal travel trends to improve suggestion accuracy. Additionally, reinforcement learning may enable dynamic adjustment of pricing models to maximize conversion rates. The model may be applied to optimize user experience by enhancing vacation package personalization.

As used herein, the term “Third-Party Service Provider” or “Service Provider” generally refers to an external entity integrated into the vacation packaging configurator's system via APIs and/or ARIs. These providers may include but are not limited to hotels, golf resorts, wellness centers, and/or activity organizers. The vacation packaging configurator can retrieve and/or update service provider data in real-time to ensure accurate pricing and availability. Additionally, third-party service providers may receive structured booking confirmations through the acceptance module. The service provider interactions may be managed through smart contract automation for seamless transaction processing.

As used herein, the term “Travel Itinerary” generally refers to an organized summary of booked vacation package components, including but not limited to lodging, activities, spa appointments, and/or golf tee times. The structured travel itinerary can be generated by the booking engine and transmitted to users upon booking confirmation. Additionally, this itinerary may be dynamically updated if modifications occur due to availability changes or user-initiated adjustments. The travel itineraries may be stored within a blockchain-based transaction module to ensure data integrity.

As used herein, the term “Vacation Packaging Engine” generally refers to a computational system component within the vacation packaging configurator that is responsible for generating, structuring, and/or finalizing vacation packages based on real-time data inputs. The vacation packaging engine may be communicatively coupled to at least one preference profile module, real-time package availability and/or pricing module, and/or booking engine to ensure seamless coordination of user selections, inventory verification, and/or pricing adjustments. Additionally, the vacation packaging engine can retrieve and process vacation topics, dynamically construct bundled packages, and/or apply opaque pricing strategies to ensure that users receive a fully structured package without visibility into individual component costs. The vacation packaging engine may integrate with AI-driven decision support algorithms to optimize vacation package recommendations, provide alternative selections in cases of unavailability, and/or ensure compliance with predefined management rules governing pricing, service availability, and/or revenue optimization strategies.

As used herein, the term “Vacation Topics” generally refers to predefined thematic categories and/or classifications used by the vacation packaging configurator to organize, filter, and/or generate vacation package recommendations. Vacation topics may encompass a range of travel-related themes, including but not limited to luxury getaways, adventure travel, wellness retreats, golf trips, golf resorts, golf vacations, spa experiences, family-friendly destinations, and/or seasonal holiday packages. Additionally, vacation topics can be dynamically adjusted based on user preferences, browsing behavior, historical booking data, and/or real-time availability from third-party service providers. The vacation topics may be retrieved and/or processed by the vacation topics import engine, allowing the system to automatically generate structured vacation packages that align with a user's selected theme. Moreover, vacation topics may be utilized by AI-based personalization engines to refine and optimize vacation package recommendations, ensuring that users receive curated options tailored to their travel interests and/or budget constraints.

As used herein, the term “Vacation Topics Import Engine” generally refers to a system component within the vacation packaging configurator that retrieves, processes, and/or categorizes vacation topics to generate structured vacation package options. The vacation topics import engine may be communicatively coupled to at least one preference profile module, AI-based personalization engine, and/or real-time package availability and/or pricing module to ensure that imported vacation topics align with user preferences, availability constraints, and/or pricing structures. Additionally, the vacation topics import engine can aggregate vacation-related data from multiple sources, including third-party service providers, internal destination databases, and/or external travel platforms, to create curated vacation package recommendations. The vacation topics import engine may apply machine-learning-based classification algorithms (e.g., the multifactorial AI decision support algorithm) to dynamically categorize vacation topics based on historical booking trends, user engagement metrics, and/or seasonality factors, ensuring that vacation package selections remain relevant and personalized.

The terms “about,” “approximately,” or “roughly” as used herein refer to being within an acceptable error range for the particular value as determined by one of ordinary skill in the art, which will depend in part on how the value is measured or determined, i.e., the limitations of the measurement system, i.e., the degree of precision required for a particular purpose, such real-time pricing of an activity and/or hotel. As used herein, “about,” “approximately,” or “roughly” refer to within ±25% of the numerical.

All numerical designations, such as pH, temperature, pricing, time, concentration, and/or molecular weight, including ranges, are approximations which are varied up or down by increments of 1.0, 0.1, 0.01 or 0.001 as appropriate. It is to be understood, even if it is not always explicitly stated, that all numerical designations are preceded by the terms “about,” “approximately,” or “roughly.” It is also to be understood, even if it is not always explicitly stated, that the compounds, components, modules, and/or structures described herein are merely exemplary and that equivalents of such are known in the art and/or can be substituted for the compounds, components, modules, and/or structures explicitly stated herein.

Wherever the term “at least,” “greater than,” or “greater than or equal to” precedes the first numerical value in a series of one or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of one or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Vacation Packaging Configurator

The present invention pertains to an integrated vacation packaging configurator system (e.g., a platform, a program, and/or software) (hereinafter “vacation packaging configurator”, “vacation packaging configurator system”, “vacation packaging configurator platform” and/or “vacation packaging configurator software”) and method for optimizing structuring, booking, and/or viewing at least one travel itinerary (e.g., trip), vacation package (e.g., vacation), and/or property package in real-time. In an embodiment, the vacation packaging configurator may be configured to communicatively couple and/or interface with any third-party travel, hotel, and/or vacation software, program, platform, and/or computing device known in the art, via any Availability, Rates, and Inventor (hereinafter “ARI”) interface software and/or programming, and/or booking Application Programming Interface (hereinafter “API”) software and/or programming known in the art. In this manner, the integrated vacation packaging configurator may include an integrated platform—such as a website, a mobile application, and/or any software applicable to any computing device known in the art, such that the vacation platform may be configured to interact with a user through at least one user interface (e.g., a graphical user interface comprising a display device) communicatively couple to the computing device of the vacation packaging configurator, and/or may be configured to provide the user, with a significantly cased vacation experience through the vacation package, removing any need to personally plan, explore, and/or book individual components of the desired vacation of the user. In this manner, the computing device of the vacation packaging configurator may comprise a processor. As such, the vacation packaging configurator may also be configured to interface and/or be uploaded within at least one alternative computing device and/or at least one third-party computing device.

In addition, the processor may comprise at least one multifactorial artificial intelligence (hereinafter “AI”) decision support algorithm having at least one neural network configured to ensure that the vacation packaging configurator may dynamically adapt to user preferences and behavior. Furthermore, the vacation packaging configurator may comprise and/or utilize a blockchain-based transaction system to enhance data transparency, security, and/or transaction integrity of each vacation package and/or property package.

In an embodiment, the vacation packaging configurator may selectively verify and/or cache at least one vacation topic of a plurality of travel topics. In this manner, the vacation packaging configurator, via API, may be configured to perform an inquiry for a specified vacation topic of a plurality of travel topics, such that the vacation packaging configurator may be configured to interface with at least one third-party software, program, and/or computing device comprising all associated data and/or import all associated data into a local dataset within the computing device. Subsequently, in this embodiment, the vacation packaging configurator may cache the ARI of the vacation topic, via interfacing with any third-party software, program, and/or computing device comprising the associated data and/or save all imported associated data within the local data set. As such, the vacation packaging configurator may associate certain preference profiles with the at least one of a plurality of travel topics, allowing a user, via the computing device, to find the at least one vacation topic via selecting the certain preference profiles.

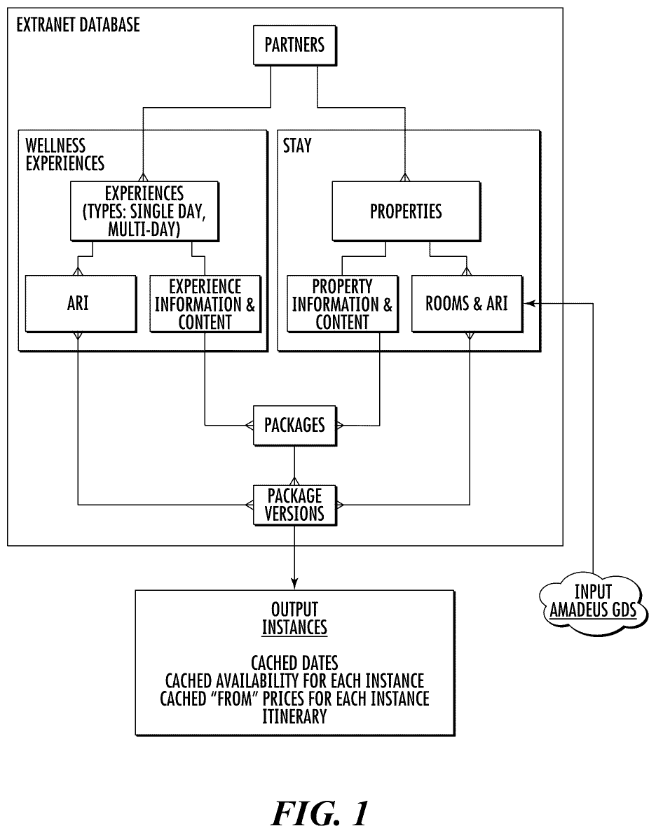

FIG. 1 depicts the vacation packaging configurator integrated with internal and/or external data sources, creating both standard vacation packages and/or user-specific vacation packages, according to an embodiment of the present disclosure. In some embodiments, the vacation packaging configurator may be configured to integrate and/or communicate with only an internal data source. In this manner, in some embodiments, the integrated vacation packaging configurator system may integrate at least one of a plurality of external data source.

In an embodiment, as shown in FIG. 1, the vacation packaging configurator may import data through the API, incorporating ARI data and/or any additional data associated with at least one of the plurality of travel topics within the software, program, platform, and/or computing device. As such, in this embodiment, the ARI data and/or additional data may be collected and/or cached from at least one third party database (e.g., a travel agency database (e.g., Amadeus GDS)), such that the vacation packaging configurator, via API, may search and/or cache associated data related to at least one of the plurality of travel topics on a local database. Additionally, in some embodiments, the user may provide the data to the vacation packaging configurator through at least one data storage device (e.g., a USB interface), via the computing device.

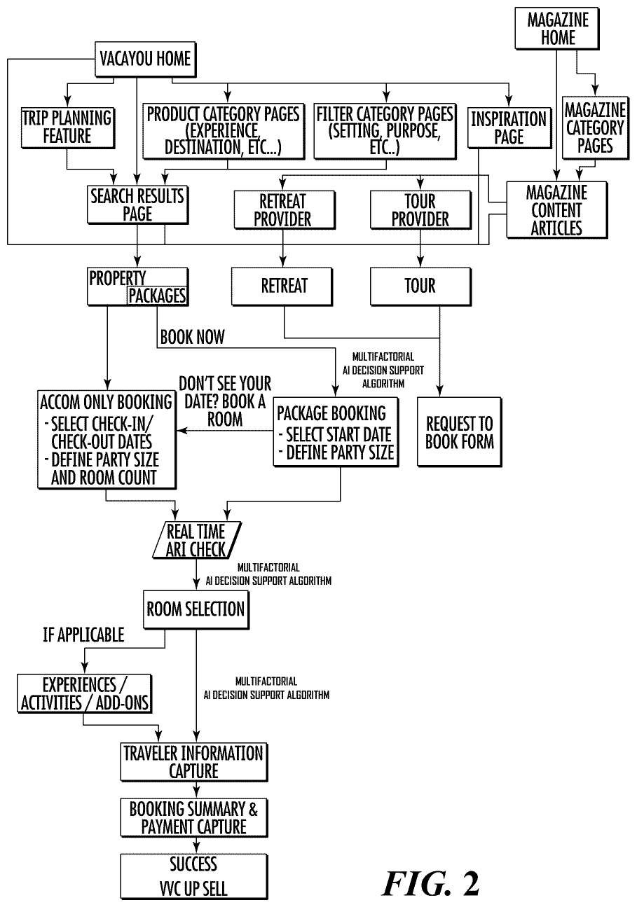

Moreover, in an embodiment, when vacation topics are sorted and combined into a vacation package, the integrated vacation packaging configurator may filter at least one of the plurality of travel topics through at least one compatibility algorithm outputting a specific value describing the dynamism of at least one vacation topic and/or at least one vacation topic grouping of the plurality of travel topics. In this manner, as shown in FIGS. 1-2, in this embodiment, the plurality of travel topics may be filtered into at least two major categories, such as a wellness experience and/or a property. Accordingly, a plurality of wellness experiences may be grouped with a plurality of properties based on a plurality of preference profiles, including but not limited to, location, availability, price, and/or user reviews.

In some embodiments, the vacation topics may be individually selected, such that the user may sort and/or filter at least one vacation topic of the plurality of travel topics. As such, in these other embodiments, the user may build a personalized vacation package. Additionally, the vacation packaging configurator may add or remove at least one wellness experience and/or property from the package to increase and/or decrease the purported dynamism value. Moreover, in some embodiments, the vacation packaging configurator may be configured to identify and/or associate the user and/or at least one guest with the at least one selected wellness experience and/or property, via the at least one user interface. Furthermore, in an embodiment, as shown in FIG. 1, compatibility of vacation topics may be calculated by an internal data source (e.g., an equation and/or algorithm) and/or a third-party software, such that the vacation packaging configurator may interact with the third-party software through the API.

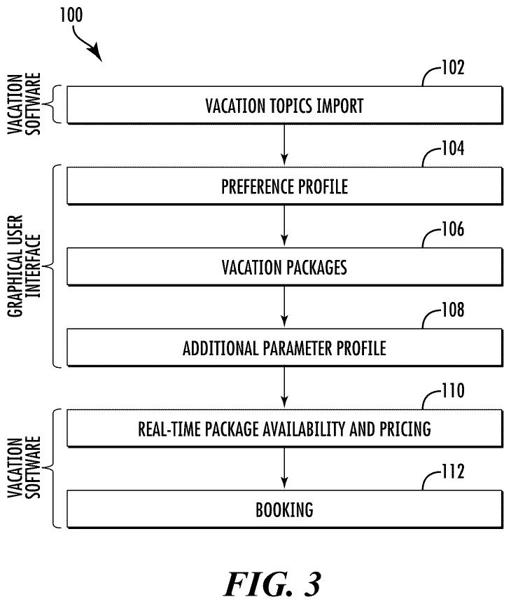

Another feature of the present disclosure is that vacation topics import engine 102 of vacation packaging configurator 100 may merge and/or combine, via a real-time inventory module communicatively coupled to the processor, an individual pricing of the at least one wellness category and/or the at least one property, such that the vacation packaging configurator may provide the user with an estimated total cost of the personalized vacation package. In this embodiment, as shown in FIG. 2, the vacation packaging configurator may utilize the ARI to query a real-time cost in order to verify accuracy of the estimated total cost. As such, the estimated total cost and/or available date range for the personalized vacation package may be readily displayed on the at least one user interface (e.g., graphical user interface) of the computing device, such that the user may be automatically notified of the cost and/or any potential price and/or availability changes, in real-time, via any auditory, visual, and/or tactile notification known in the art. Moreover, as shown in FIGS. 1-2, in conjunction with FIG. 3, in an embodiment, the real-time inventory module may continuously synchronize with third-party hotel and/or activity provider databases. As such, the vacation package configurator, via at least one third-party database imported via the at least one ARI and/or API, may display only the currently available inventory at any given moment, ensuring that users do not book unavailable accommodations or activities. Moreover, the real-time synchronization of inventory may enable instant updates if a package component becomes unavailable during the selection process. In addition, by leveraging AI-driven availability prediction, the vacation packaging may provide real-time alternative suggestions if a preferred selection is no longer available.

Additionally, in this embodiment, the vacation packaging configurator may also comprise a customizable white-label interface. The customizable white-label interface may allow hotels, resorts, and/or third-party service providers to incorporate their branding and/or business logic. In this manner, the vacation packaging configurator may integrate directly into their existing booking workflows while maintaining brand consistency.

In some embodiments, the blockchain-based transaction system of the vacation packaging configurator may comprise a smart contract framework, such that the smart contract framework may be deployed to automate the execution of vacation package transactions, ensuring that all parties adhere to predefined licensing agreements, as shown in FIGS. 1-3. As such, in these other embodiments, the service providers (e.g., hotel and/or activity providers) may register their services onto the smart contract-enabled blockchain-based transaction system of the vacation packaging configurator, enabling automated rate adjustments and/or inventory updates without manual intervention. In this manner, if a service provider (e.g., hotel and/or activity provider) updates pricing parameters, the smart contract may dynamically enforce the new rate structure, ensuring pricing consistency across platforms. Additionally, in these other embodiments, the blockchain-based transaction system may also comprise a decentralized ledger communicatively coupled to the processor and/or a memory of at least one server and/or a memory of the at least one computing device, such that the decentralized ledger may allow instant payment settlements, reducing the time required for financial reconciliation between service providers (e.g., hotel providers and/or activity providers (e.g., hotels, golf courses, and wellness centers)). Moreover, in these other embodiments, the blockchain-based transaction system of the vacation packaging configurator may integrate multi-party revenue-sharing models into the blockchain ecosystem, ensuring that all service providers may receive their respective payouts automatically upon booking confirmation.

In some embodiments, the decentralized ledger of the blockchain-based transaction system may also facilitate the real-time inventory synchronization module, ensuring that availability updates across third-party hotel and activity providers remain tamper-proof, as shown in FIG. 1 and FIG. 2. As such, when a user selects a vacation package, the blockchain network may instantly verify the validity of the selection, preventing cases where the displayed availability differs from the actual availability. In this manner, real-time consensus mechanisms (e.g., the at least one multifactorial AI decision support algorithm) may be utilized to ensure that all booking partners operate on a single source of truth, reducing overbooking risks. Additionally, as shown in FIG. 3, the smart contract automation may allow instant refunds, via the booking engine 112, in cases where a reservation fails due to unforeseen availability conflicts. Moreover, the decentralized ledger may eliminate disputes between service providers, as all transactions and/or availability updates may be permanently recorded on the blockchain.

In some embodiments, the integrated vacation packaging configurator may search and/or cache vacation topic data. Accordingly, in these other embodiments, the integrated vacation packaging configurator interface may also be configured to automatically display equivalent room rates of the vacation package on the at least one user interface.

Moreover, as shown in FIG. 2, in an embodiment, after the real-time cost has been verified, the user may be provided with additional parameters, including but not limited to, room selection, add-ons (e.g., experiences, activities, and/or amenities, airfare, airline information, rental vehicle information), traveler information capture, payment capture, booking engine, and/or any information profile known in the art, which a user may interact with in selecting a hotel and/or vacation. In this manner, as shown in FIG. 2, in this embodiment, the booking engine may be configured to initiate the ARI and/or API to query the real-time cost to determine if the cost of at least one aspect of the hotel and/or vacation package has decreased from the initial estimate as provided by the vacation packaging configurator. As such, in some embodiments, the vacation packaging configurator, may provide a refund within a predetermined amount of time to the user based on the difference between the price captured by the vacation packaging configurator and the real-time cost, as provided by the ARI and/or the API. Additionally, in some embodiments, after the ARI and/or API is utilized to query the real-time cost, the vacation packaging configurator may refund the user the difference between the price captured on the vacation packaging configurator and the actual cost of the hotel, vacation package, and/or a plurality of aspects provided by the vacation packaging configurator.

Furthermore, as shown in FIG. 2, the vacation packaging configurator may provide the user with an inspiration module, such that the inspiration module may include but is not limited to photographs, videos, 3D-tours, reviews, and/or an interactive communication system, such that the user may communicate with at least one user who had previously booked the at least one wellness experience (e.g., golf outing), the at least one property, the vacation package, and/or a similar wellness experience and/or property. In addition, as shown in FIG. 2, in this embodiment, the vacation packaging configurator may be configured to communicate with at least one third-party software, program, and/or computing device, such that the vacation packaging configurator may be configured to provide the user with additional hotel and/or vacation package information (e.g., property information and/or wellness experience information) from magazines, video blogs, web blogs, newspapers, periodical, social media, and/or any publication known in the art.

Additionally, as shown in FIG. 2, in an embodiment, the vacation packaging configurator may be communicatively coupled to a graphical administrator interface, such that an administrator of the vacation packaging configurator may make changes to at least one of the plurality vacation packages, the plurality of wellness experience, and/or the plurality of properties, in addition to managing at least one booking of the user, in real-time. For example, if the at least one property (e.g., hotel), at least one wellness experience, and/or the vacation package is shown on the vacation packaging configurator, but is currently unavailable for booking, the vacation packaging configurator may be configured to provide a user with a booking form, such that the user may input their personal information and/or payment information, via the at least one graphical user interface communicatively coupled to the vacation packaging configurator, allowing the administrator for the vacation packaging configurator to contact the at least one property, at least one wellness experience, and/or vacation package provider and/or request booking for the user. As such, the administrator may manage the real-time bookings in several ways including, but not limited to, working as an intermediary to the user by booking the selected vacation package in real-time for the user, integrating specific property and/or wellness experience coupons or deals, and/or defining a contract duration of the vacation packages, allowing the user to interact with the terms via the at least one user interface.

FIG. 3 depicts a flow diagram of modules for the vacation packaging configurator, according to an embodiment of the present disclosure. In an embodiment, the vacation packaging configurator 100 may include several aspects within the system. In this embodiment, the vacation packaging configurator 100 may comprise a plurality of travel topics import engine 102, a preference profile module 104, a vacation package engine 106, an additional parameter profile module 108, a real-time package availability and/or pricing module 110, and/or a booking engine 112. In this embodiment, the plurality of travel topics import module 102, the real-time package availability and/or pricing module 110, and/or the booking engine 112 may be primarily software based only. The preference profile module 104, the vacation packages engine 106, and/or additional parameter profile module 108 may be configured to allow the user to interact with the vacation packaging configurator 100, via the at least one user interface communicatively coupled to the vacation packaging configurator. Each of these aspects will be further detailed in the sections below.

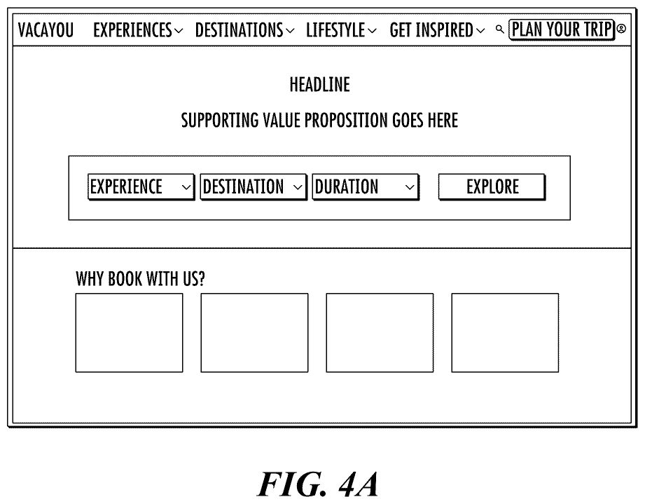

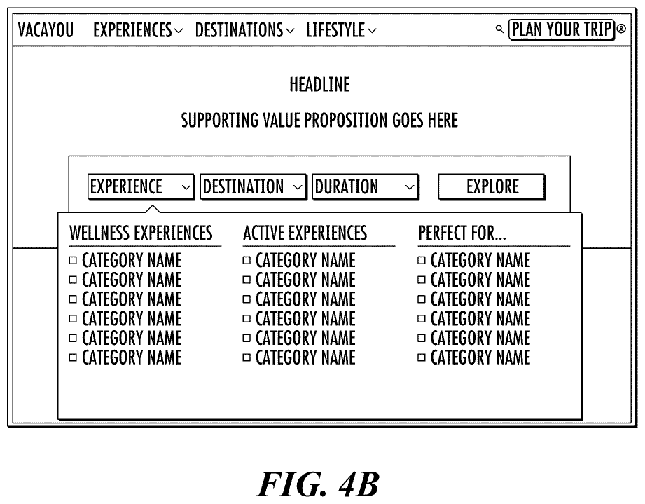

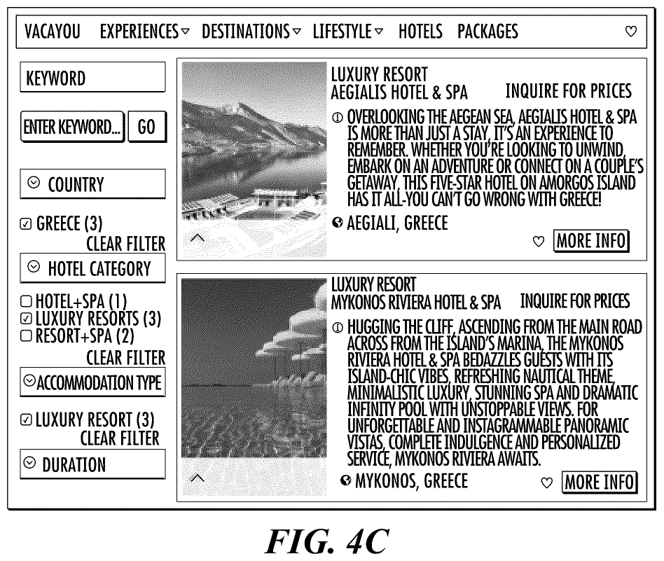

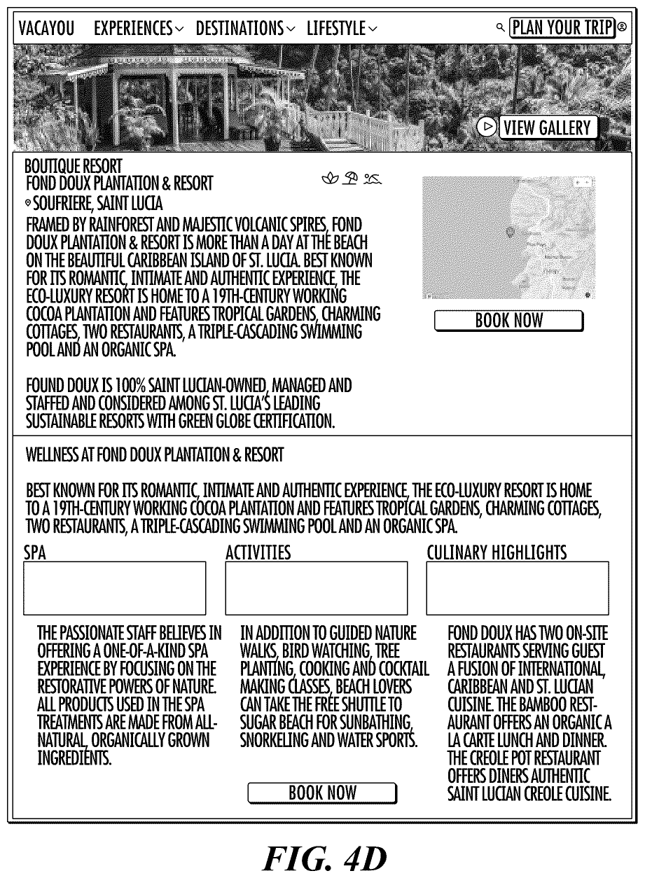

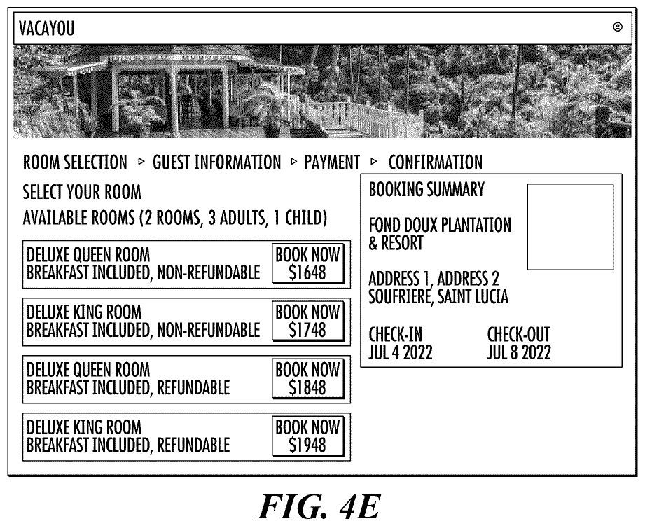

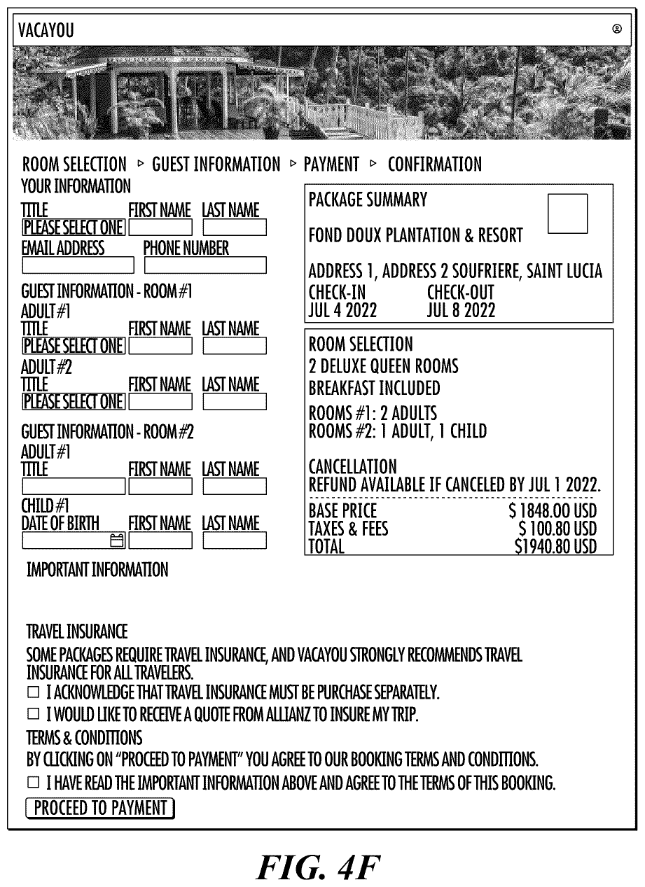

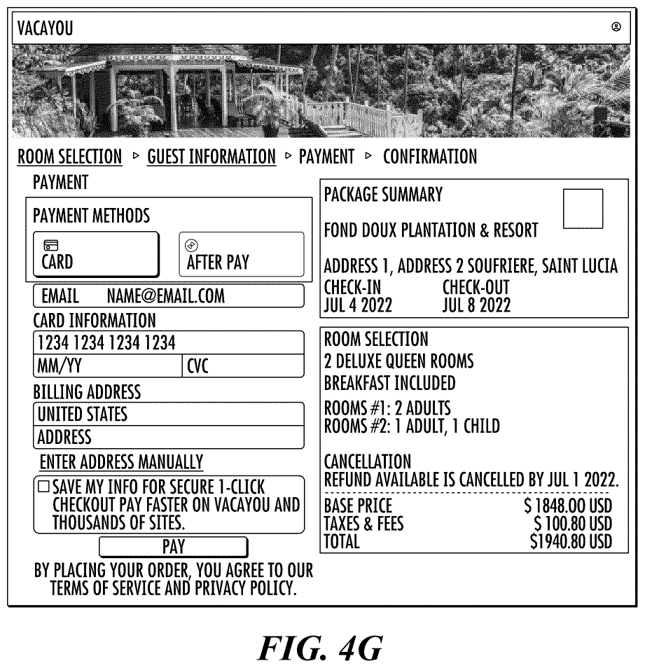

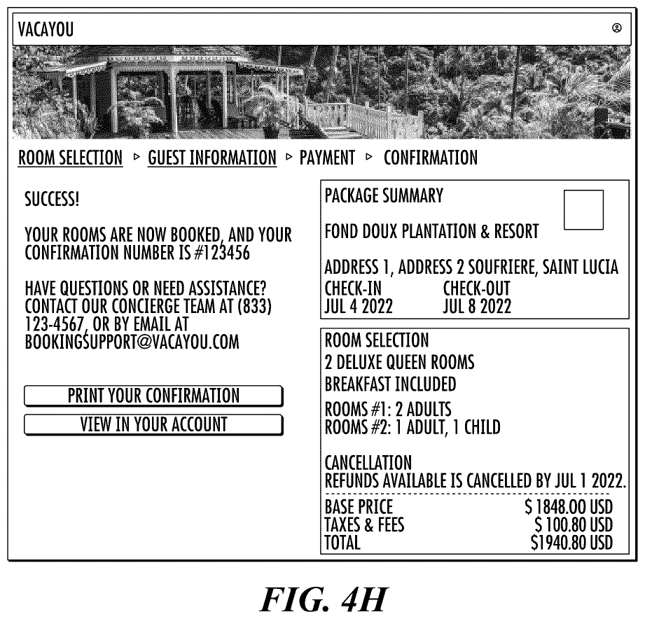

Additionally, the present disclosure may further include the selection and/or booking of predetermined property packages as shown in FIGS. 4A-4H. Accordingly, FIG. 4A depicts preference profile module 104, as shown in FIG. 3 for hotel selection on the vacation packaging configurator, according to an embodiment of the present disclosure. The preference profile module 104 may include a plurality of options, suggestions, and/or questions which the user may select, allowing the integrated vacation package configurator software to filter potential property (e.g., hotel) matches. In an embodiment, the plurality of options includes, but is not limited to, country, state and/or province, property category, accommodation type, and/or duration. Additionally, the plurality of options, suggestions, and/or questions of preference profile module 104 may increase or decrease based on the initial selection and/or continued selection by the user. For example, in some embodiments, when the user selects a country outside of the United States, the user no longer has the option to select one of the fifty (50) states within the United States.

In an embodiment, the vacation packaging configurator may automatically remove at least one of the plurality of options based on user selection, property availability, and/or wellness experience availability to allow the user to select valid and/or relevant selections, increasing the efficiency of the user on the vacation packaging configurator. Moreover, as shown in FIG. 4B, in this embodiment, when the user selects a module within one of the plurality of options, the vacation packaging configurator removes at least one alternative module within the same option. In this manner, when the user deselects the highlighted module, at least one alternative module may be replaced. Moreover, the various modules within the plurality of options may be pre-selected by the vacation packaging configurator for convenience and/or the pre-selected modules may be altered by the user via the at least one user interface communicatively coupled to the computing device in association with the vacation packaging configurator. Furthermore, in this embodiment, as shown in FIG. 4B, in conjunction with FIG. 3, at least one of the plurality of options may be removed entirely and/or grouped together to increase efficiency of the use on the vacation packaging configurator. For example, when the module “Greece” was selected, the State and/or Province option was removed from preference profile module 104.

FIGS. 4C-4D, in conjunction with FIG. 3, depict the at least one property output of the vacation packaging configurator based on the selections of the user within preference profile module 104, according to an embodiment of the present disclosure. In an embodiment, the at least one property (e.g., hotel) output may be presented in a top-down format. Accordingly, the vacation packaging configurator may present the at least one property output with the at least one property having the closest the matches to the at least one module selected by the user within the plurality of options as the first property output presented at the top of the screen. Additionally, the vacation packaging configurator may configure the at least one property output, as shown in FIG. 4C, in a condensed form with only pertinent aspects (e.g., aspects the vacation packaging configurator 100 may determine important to the user based on the at least one module selected by the user within the plurality of options within preference profile module 104) of the property provided, allowing the user to compare the at least one property output with at least one alternative property output. In this embodiment, the user may interact with each property output provided by the vacation packaging configurator, such that when the user interacts with the at least one property output, via the user interface, the vacation packaging configurator may expand the condensed form of the at least one output, such that additional details for at least one property option may be provided on a display device in association with the computing device of the vacation packaging configurator, as shown in FIG. 4D.

In some embodiments, the at least one property output may be presented in a left-to-right format. Additionally, in some embodiments, the vacation packaging configurator may provide additional recommendations for at least one alternative property option and/or style based on the preference profile of the user. For example, in these other embodiments, based on the preference profile of the user preferring villas, the vacation packaging configurator may provide at least one alternative recommendation comprising a villa property comprising the closet matches to at least one parameter selected by the user within the plurality of options of preference profile module 104. Furthermore, in an embodiment, the vacation packaging configurator may be configured to input at least one of the plurality of property options within a ranking algorithm and/or equation, such that a recommendation rating may be provided for each property option, with the property output most similar to the profile preference of the user receiving the highest rating and/or the property output least similar to the profile preference of the user receiving the lowest rating.

FIG. 4E depicts a room selection of the at least one selected property of the vacation package of the vacation packaging configurator, according to an embodiment of the present disclosure. In an embodiment, after the user selects the at least one property from at least one property outputs provided by the vacation packaging configurator, the vacation packaging configurator may be configured to display a module comprising the room selection, such that the user may interact with the room selection module, via the at least one user interface of the computing device in association with the vacation packaging configurator. Accordingly, the room selection module, as shown in FIG. 4E, in conjunction with FIG. 3, may provide the user with at least one room option based on preference profile module 104, as provided by the user. For example, for a user who inputs a preference within preference profile module 104 comprising 2 rooms, 3 adults, and one child, the room selection may provide several options which may match and/or as closely conform to the preference profile (e.g., a deluxe queen room, a deluxe king room, standard queen room, a standard king room), as possible.

Furthermore, in an embodiment, the room selection module may display at least one experience, activity, and/or add-ons (e.g., rental vehicle, airfare, airline, kayaking, hiking, all-inclusive meals, complimentary Wi-Fi). Accordingly, in this embodiment, the user may interact with the room selection module, via at least one user interface of the computing device, such that the user may select the room based on the size, experiences, activities, add-ons provided for the particular room based on the property package, and/or any other room category known in the art. Additionally, as shown in FIGS. 4E-4G, the vacation packaging configurator may display a property package summary, including but not limited to the selected property package location, the check-in and/or check-out time of the selected property package, the additional inclusions of the selected property package, the estimated cost of the selected property package, as provided by the vacation packaging configurator, refund information, and/or any information known in the art which would be included in booking a hotel.

In an embodiment, once the user has selected the predetermined vacation package and/or property package, the integrated vacation package configurator software may configure the display device and/or the at least one user interface (e.g., graphical user interface) in association with the computing device for the vacation packaging configurator to display traveler information capture, a payment capture and/or a booking engine, as shown in FIGS. 4F-4H. Additionally, in this embodiment, the vacation packaging configurator may be configured to automatically book cancellation policies associated with the individual aspects of the predetermined property package and/or the predetermined vacation package without explicit user interaction. As shown in FIG. 4F, in an embodiment, the traveler capture may comprise a module where the user may input their personal information and/or the personal information of at least one guest, via the at least one user interface of the computing device. As such, in this embodiment, the user, via the at least one user interface, may select, assign, and/or identify at least one aspect of the predetermined property package and/or the predetermined vacation package to the user and/or the at least one guest. In this manner, the at least one guest may be able to participate in at least one aspect of the predetermined property package and/or the predetermined vacation package, whereas the user may be able to participate in at least one alternative aspect of the predetermined property package and/or the predetermined vacation package. Moreover, the user may be able to alter assignment of the at least one aspect to the user and/or the at least one guest after receiving confirmation of a booking of the predetermined vacation package and/or the predetermined property backage, via a edit a booking engine within a profile module created for the user within the vacation packaging configurator, via the at least one user interface of the computing device in association with the vacation packaging configurator.

In addition, in an embodiment, the traveler capture module may include a section where the user can provide a desired check-in date and a desired check-out date. Additionally, as shown in FIG. 4G, in an embodiment, information for at least one payment method (e.g., credit cards, debit cards, Apple Pay, Venmo, Cryptocurrency) may be inputted by the user and cached by the vacation packaging configurator to complete all transactions, thereby reducing complexity of the booking process for the user, via the graphical user interface of the computing device. As such, the payment capture may display as a module and/or be configured to allow the user to input additional payment information from at least one additional third-party software in order to allow the user to pay through a predetermined payment software (e.g., monthly payments), via the at least one user interface of the computing device. For example, the user may input their profile data from a third-party payment software (e.g., Afterpay), such that the vacation packaging configurator may communicate with the third-party payment software, allowing the third-party payment software to provide the payment of the user at a predetermined time.

As shown in FIG. 4H, once the payment capture has been completed, the vacation packaging configurator may be configured to display a booking engine, via the at least one user interface of the computing device in association with the vacation packaging configurator. In this embodiment, the booking engine may display a notification indicative of a successful and/or a non-successful booking. In this manner, the vacation packaging configurator may be configured to utilize API and/or ARI to confirm that all aspects of the selected property package are available and have been booked by the vacation packaging configurator. Accordingly, if at least one aspect of the property package platform is no longer available, the vacation packaging configurator may be configured to display a notification in the booking engine indicative of a non-successful booking, via at least one user interface of the computing device.

As shown in FIGS. 4A-4H, in conjunction with FIG. 3, in an embodiment, the at least one multifactorial AI decision support algorithm may analyze user preferences, browsing behavior, and/or booking history to generate highly tailored vacation package recommendations. As such, in this embodiment, the at least one multifactorial AI decision support algorithm may be communicatively coupled to the processor, such that the processor, via the at least one vacation packages engine 106, the preference profile module 104, and/or the additional parameter profile module 108, may predict user intent, dynamically adjusting suggested packages to maximize relevance and/or booking likelihood based on at least one predetermined revenue management rule, as determined by the administrator and/or the at least one multifactorial AI decision support algorithm.

In an embodiment, as shown in FIGS. 4E-4H, in conjunction with FIG. 3, vacation packaging configurator 100 may include a unified cart design, allowing seamless integration of at least one travel topic (e.g., room reservations, golf tee times, spa appointments, and/or wellness experiences) provided by the at least one service provider into a single, streamlined booking cart. The unified cart can eliminate the need for multiple separate transactions, improving the efficiency of the booking process. As such, in this embodiment, the at least one user may add, modify, and/or remove package components in real time without navigating away from the interface. In this manner, licensees may provide a simplified, all-in-one booking experience that consolidates various travel components, ensuring a more convenient and frictionless transaction flow.

Furthermore, in some embodiments, once the user has successfully been inputted, the vacation packaging configurator may be configured to utilize the ARI to query the real-time cost of at least one aspect of the selected property package. As such, if at least one aspect of the selected property package has decreased, the booking engine may be configured to automatically display a notification indicative of the vacation packaging configurator comprising a higher cost than necessary. Accordingly, in these other embodiments, the vacation packaging configurator may be configured to refund, via the inputted payment information provided by the user and/or at least one other payment method provided by the user, the difference in the real-time cost determined by the ARI and/or the estimated cost provided by the integrated vacation packaging configurator in a predetermined amount of time. Moreover, in some embodiments, the vacation packaging configurator may be configured to automatically refund the user, via the inputted payment information provided by user and/or at least one other payment method provided by the user, the difference in the real-time cost as determined by the ARI and the estimated cost provided by the integrated vacation packaging configurator platform.

In some embodiments, as shown in FIG. 4A-4H, in conjunction with FIG. 3, as stated above, the blockchain-based transaction system, via the processor, may be communicatively coupled to the vacation packages engine 106 and/or the booking engine 112 of the vacation packaging configurator, such that the blockchain-based transaction system may enhance data transparency, security, and/or transaction integrity of the hotel packages and/or the vacation packages. As such, in these other embodiments, each booking modification, including but not limited to room reservations, golf tee times, spa appointments, and/or wellness experiences, may be stored on the distributed ledger of the blockchain-based transaction system, ensuring that availability updates remain immutable and/or verifiable. In this manner, fraudulent booking claims and/or inconsistencies in reservation records by the at least one user of the at least one hotel package and/or vacation package may be eliminated, as all transactional updates may be validated across a decentralized network. Additionally, the blockchain-based transaction system may comprise timestamping mechanisms to allow service providers and/or the at least one user to track modifications made to their booking history, such that the vacation packaging configurator may prevent double-booking issues by requiring smart contract validation before finalizing a booking selection.

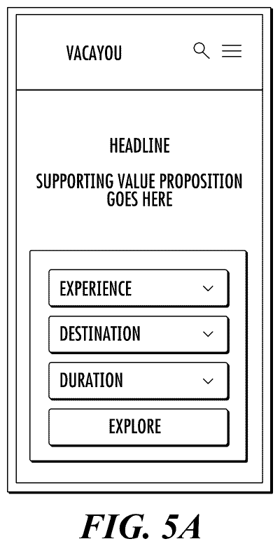

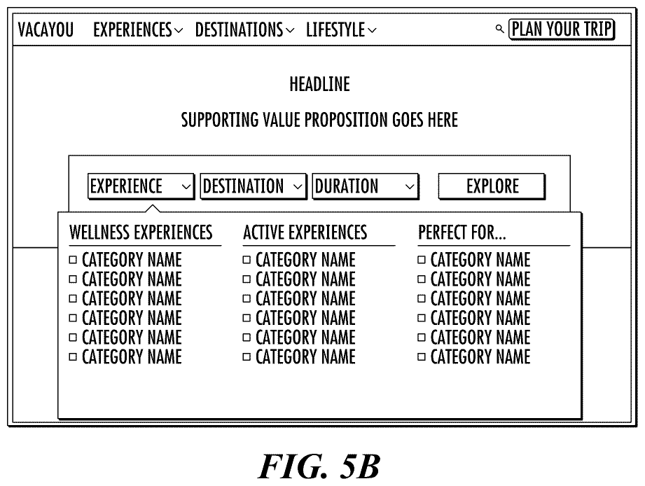

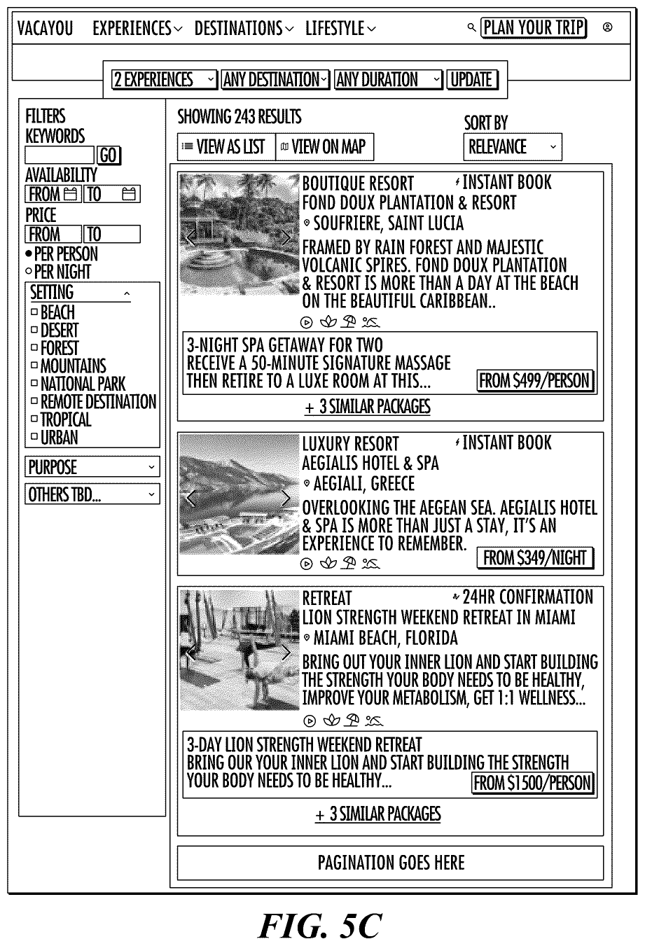

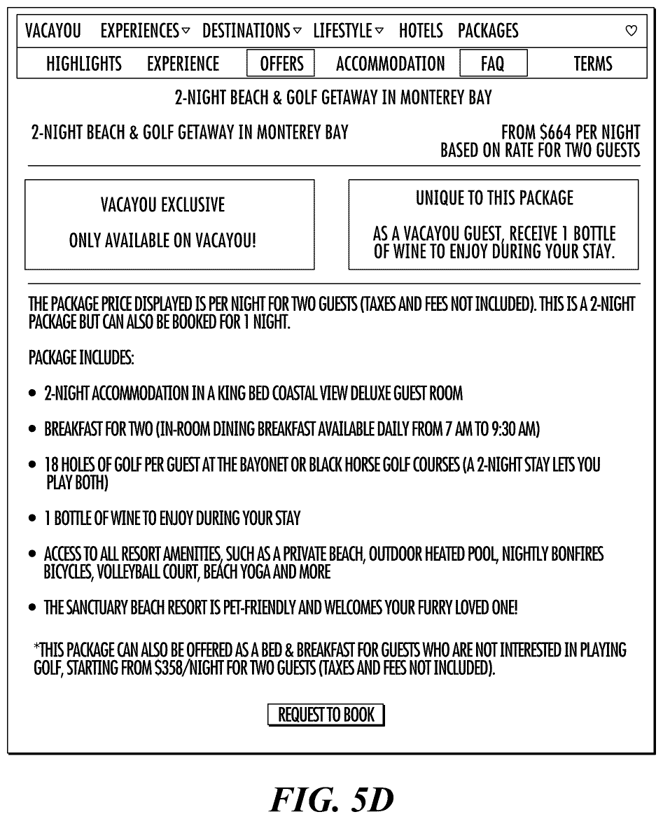

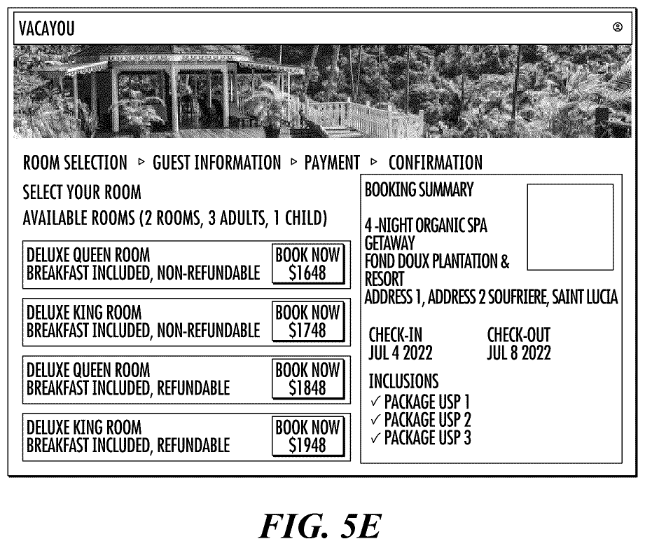

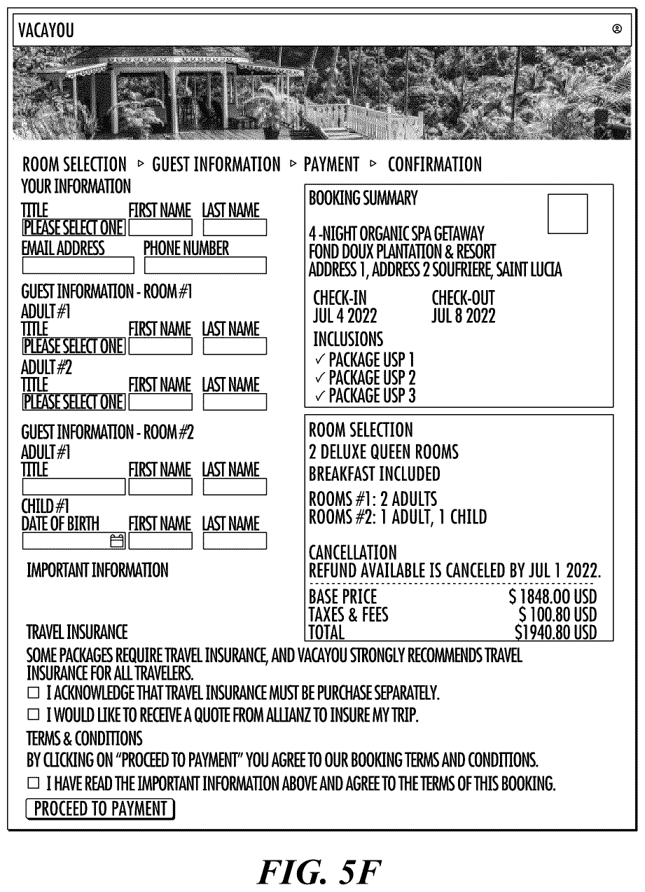

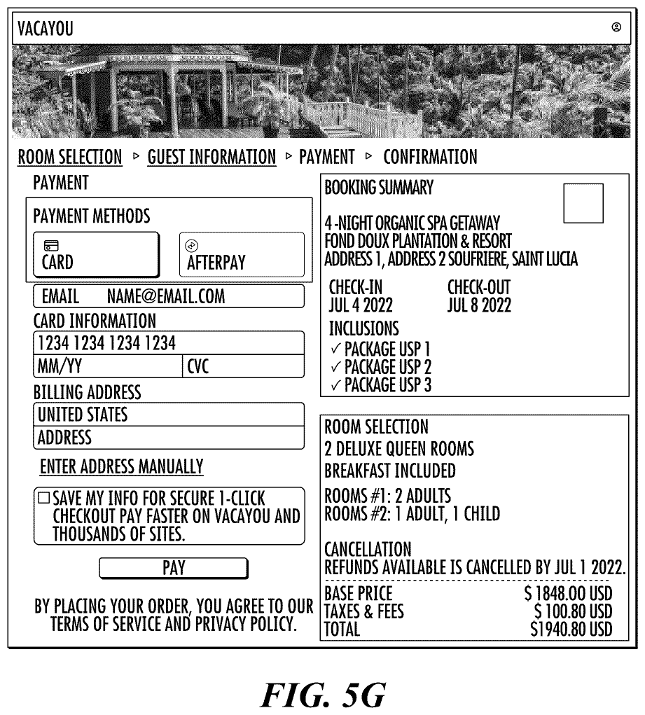

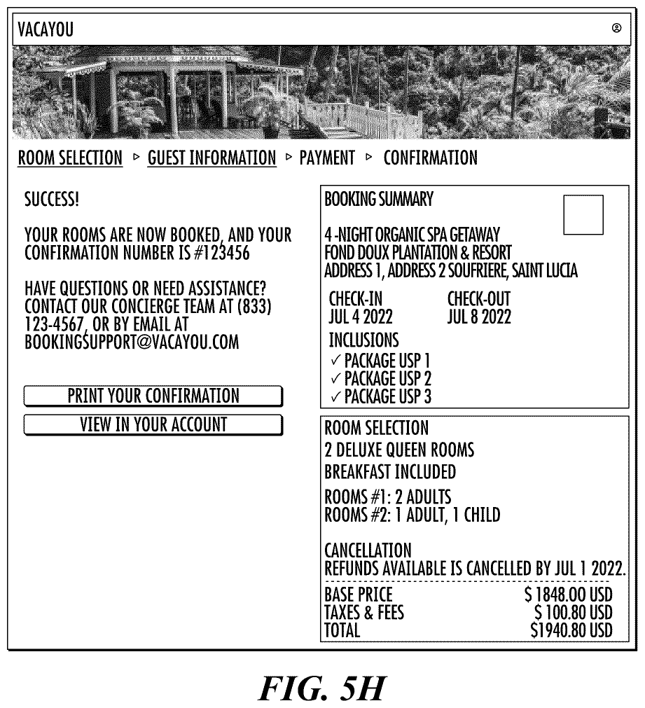

Moreover, another aspect of the present disclosure may further include the selection and booking of predetermined vacation packages as shown in FIGS. 5A-5H. FIG. 5A depicts an exemplary configuration of a vacation package preference profile of a vacation packaging configurator, according to an embodiment of the present disclosure. The preference profile module 104 may include a plurality of options which the user may select, allowing the integrated vacation packaging configurator software to filter the potential predetermined vacation package matches. In an embodiment, the plurality of options includes, but is not limited to, country, state or province, perfect for, package type, setting, and/or duration. Additionally, the plurality of options of the preference profile module 104 may increase or decrease based on the initial user selection. For example, in some embodiments, when the user selects a country outside of the United States, the user no longer has the option to select one of the fifty (50) states within the United States. In these other embodiments, the vacation packaging configurator automatically removes these options to allow the user to select valid and relevant selections, increasing the efficiency of the user on the vacation packaging configurator. Additionally, in some embodiments, the preference profile, the predetermined vacation packages may be filtered into several options, including but not limited to, active tour, getaway, immersive wellness, and/or retreat.

Moreover, as shown in FIG. 5B, in some embodiments, when the user selects a module within one of the plurality of options, the vacation packaging configurator may remove at least one alternative module within the same option. In this manner, when the user deselects the highlighted module, the at least one alternative module may be replaced. In some embodiments, the various modules within the plurality of options may be pre-selected by the vacation packaging configurator for convenience and may be altered by the user via the graphical user interface of a computing device. Furthermore, in some embodiments, as shown in FIG. 5B, some of the plurality of options may be removed entirely or grouped together to increase efficiency of the use on the vacation packaging configurator. For example, when the modules, such as “Beach” and “California” are selected, at least one alternative module within the “State or Province” option and “Setting” option may be removed from the preference profile module 104. In this manner, when the “California” module was selected, all alternative modules under the “Country” option may be removed from the selection.

Additionally, as shown in FIGS. 5A-5B, in conjunction with FIG. 3, the at least one user interface of the vacation packaging configurator may be designed to ensure optimal user engagement on both mobile and desktop platforms. The responsive design may allow for quick modifications, ensuring that the at least one user can seamlessly navigate, browse, and/or confirm bookings without experiencing interface fragmentation. In this manner, the vacation packaging configurator may reduce booking abandonment rates by providing an intuitive and accessible user experience.

In some embodiments, as shown in FIGS. 5A-5B, in conjunction with FIG. 3, the blockchain-based transaction system may comprise identity verification, such that the vacation packaging configurator may enhance the security of white-label customization features, ensuring that only authorized service providers can make branding and/or functional modifications within the platform and/or the at least one user interface of the vacation packaging configurator. As such, each contractual permission of the service providers may be cryptographically secured, via the blockchain-based transaction system, preventing unauthorized changes to package structures, pricing models, and/or branding elements. In this manner, service providers may establish a trustless environment, where all branding customizations may be stored on the immutable decentralized ledger, ensuring consistency across multiple platforms. Additionally, in these other embodiments, blockchain identity management may allow preference profiles of the at least one user, via the preference profile module 104 and/or the booking engine 112 being communicatively coupled to the blockchain-based transaction system, to be linked securely to previously booked packages, enabling personalized recommendations without compromising user privacy. Moreover, in these other embodiments, the service providers may utilize non-fungible token (hereinafter “NFT”) smart contracts to manage exclusive access packages, where the at least one user may unlock premium travel experiences through blockchain-based vouchers (e.g., acquiring and/or spending a predetermined amount of cryptocurrency and/or acquiring possession of a predetermined NFT).

FIGS. 5C-5D depict the predetermined vacation package of the vacation packaging configurator based on the selections of the user within the preference profile module 104, according to an embodiment of the present disclosure. In an embodiment, the hotel outputs may be presented in a top-down format. Accordingly, the vacation packaging configurator may present the predetermined vacation packages with the predetermined vacation package having closest matches to the user as the first vacation package presented at the top of the screen. Additionally, the vacation packaging configurator configures the predetermined vacation package, as shown in FIG. 5C, in a condensed form with only key aspects of the hotel provided, allowing the user to compare multiple vacation packages. As such, the user may interact with each predetermined vacation package provided by the vacation packaging configurator, provided additional details for each option, as shown in FIG. 5D. In some embodiments, the predetermined vacation packages may be presented in a left-to-right format.

In an embodiment, as shown in FIG. 5C, the vacation packaging configurator may automatically filter and provide the predetermined vacation platform with an activity rating, via an intensity algorithm. In this manner, the intensity algorithm of the vacation packaging configurator may be configured to input each of the plurality of activities within the predetermine vacation package, such that a rating may be provided relating to how active and/or strenuous the vacation package is considered. As such, the user may be allowed to see the activity rating on a module of the vacation packaging configurator, via the display device and/or the at least one user interface (e.g., a graphical user interface) to determine the level of activity and/or strain will be required within the predetermined vacation package. The rating categories may include, but are not limited to, relaxing, moderate, brisk, and/or intense. For example, four (4) day and/or night Organic Spa Getaway in Saint Lucia may be given a relaxing rating, while a seven (7) day and/or night Himalaya Everest Base Camp Trek may be given an intense rating by the vacation packaging configurator. Additionally, in some embodiments, the vacation packaging configurator may provide recommendations for predetermined vacation packages based on the preference profile of the user. Accordingly, a recommendation rating may be provided for each vacation package, with the predetermined vacation package most similar to the profile preference of the user receiving the highest rating and the vacation package least similar to the profile preference of the user receiving the lowest rating.

Another feature of the present disclosure is that the vacation packaging configurator, as shown in FIG. 5D, provides a detailed breakdown of the predetermined vacation package. The detailed breakdown may include but is not limited to, the duration of the stay, the features of the hotel, spa, and/or golf course, any potential food, unique aspects only provided by the vacation packaging configurator, and/or if the package is exclusive to the vacation packaging configurator. In some embodiments, the detailed breakdown may also incorporate highlights of the predetermined vacation package, reviews of the vacation package by previous users, photos and/or videos of the experience by previous users, a frequently asked questions section, and/or refund and/or cancellation terms for the predetermined vacation package.

FIG. 5E depicts a room selection of a selected vacation package of a vacation packaging configurator, according to an embodiment of the present disclosure. In an embodiment, after the user selects a property (e.g., hotel) package from the property outputs provided by the vacation packaging configurator, the vacation packaging configurator may be configured to display a module comprising the room selection, such that a user may interaction with the room selection module, via the graphical user interface of the computing device. Accordingly, the room selection module, as shown in FIG. 5E, may provide the user with at least one room option based on the preference profile as provided by the user. For example, for a user who inputs a preference profile comprising 2 rooms, 3 adults, and one child, the room selection may provide several options which may conform to the preference profile (e.g., a deluxe queen room, a deluxe king room, standard queen room, a standard king room). Furthermore, in some embodiments, the room selection module may display at least experience, activity, and/or add-ons (e.g., rental vehicle, airfare, airline, kayaking, hiking, all-inclusive meals, complimentary Wi-Fi). Accordingly, in these other embodiments, the user may interact with the room selection module, via the graphical user interface of the computing device, such that the user may select the room based on the size, experiences, activities, and/or add-ons provided for the particular room based on the property package. Additionally, as shown in FIGS. 5E-5G, the vacation packaging configurator may display a vacation package summary, including but not limited to the selected vacation package location, the check-in and/or check-out time of the selected vacation package, the additional inclusions of the selected vacation package, the estimated cost of the selected vacation package, as provided by the vacation packaging configurator, refund information, and/or any information known in the art which would be included in booking a vacation package.

In an embodiment, once the user has selected the predetermined vacation package, the integrated vacation packaging configurator software may configure the at least one user interface (e.g., a graphical user interface) to display traveler information capture, a payment capture and/or a booking engine, as shown in FIGS. 5F-5H. Additionally, the vacation packaging configurator may be configured to automatically book cancellation policies associated with the individual aspects of the predetermined vacation package without explicit user interaction. As shown in FIG. 5F, the traveler capture may comprise a module where the user may input their personal information and/or the personal information of at least one guest, via the graphical user interface of the computing device. In some embodiments, the traveler capture module may include a section where the user can provide a desired check-in date and a desired check-out date. Additionally, as shown in FIG. 5G, in an embodiment, information for at least one method of payment (e.g., credit cards, debit cards, Apple Pay, Venmo, Cryptocurrency) may be inputted by the user and cached by the vacation packaging configurator to complete all transactions, thereby reducing complexity of the booking process for the user, via the graphical user interface of the computing device. As such, the payment capture module may be configured to allow the user to input additional payment information from at least one additional third-party software in order to allow the user to pay through a predetermined payment software (e.g., monthly payments), via the graphical user interface of the computing device. For example, the user may input their profile data from a third-party payment software (e.g., Afterpay), such that the vacation packaging configurator may communicate with the third-party payment software, allowing the third-party payment software to provide the payment of the user at a predetermined time.

As shown in FIG. 5H, once the payment capture has been completed, the vacation packaging configurator may be configured to display a booking engine, via the graphical user interface of the computing device. In this embodiment, the booking engine may display a notification indicative of a successful and/or a non-successful booking. In this manner, the vacation packaging configurator may be configured to utilize API and/or ARI to confirm that all aspects of the selected vacation package and/or selected property package are available and have been booked by the vacation packaging configurator. Accordingly, if at least one aspect of the vacation package and/or at least one option of the property package are no longer available, the vacation packaging configurator may be configured to display a notification in the booking engine indicative of a non-successful booking, via the graphical user interface of the computing device.

Furthermore, in some embodiments, once the user has successfully inputted the vacation packaging configurator may be configured to utilize the ARI to query the real-time cost of at least one aspect of the selected vacation package and/or the selected property package. As such, if at least one aspect of the selected vacation package and/or the selected property package has decreased, the booking engine may be configured to automatically display a notification indicative of the vacation packaging configurator comprising a higher cost than necessary. Accordingly, in these other embodiments, the vacation packaging configurator may be configured to refund, via the inputted payment information provided by the user and/or at least one other payment method provided by the user, the difference in the real-time cost determined by the ARI and/or the estimate cost provided by the integrated vacation packaging configurator in a predetermined amount of time, providing the user with the lowest-cost available for the selected vacation package and/or the property package. Moreover, in some embodiments, the vacation packaging configurator may be configured to automatically refund the user, via the inputted payment information provided by user and/or at least one other payment method provided by the user, the difference in the real-time cost as determined by the ARI and the estimated cost provided by the integrated vacation packaging configurator platform.

In an embodiment, the booking engine may include but is not limited to hotels, golf courses, spa retreats, hiking trips, flights, car rentals, restaurants, tours, and/or attractions. The vacation packaging configurator may be configured to use API to send the booking details to the aspects of the selected vacation package and/or property package to make the booking requests. In some embodiments, the vacation packaging configurator may be configured to allow the user to visit the third-parties associated with the selected vacation package and/or the selected property package to verify availability and price. In some embodiments, the vacation packaging configurator may automatically verify the availability and/or price of the aspects within the selected vacation package and/or the selected property package. Additionally, in some embodiments, the user may be able to view their reservation in one location on the vacation packaging configurator. In some embodiments, if the booking may be modified and/or cancelled, the vacation packaging configurator may be configured to allow the user to cancel and/or modify the booking, accordingly.

Additionally, as shown in FIGS. 5A-5H, in conjunction with FIG. 3, in an embodiment, the at least one multifactorial AI decision support algorithm may be communicatively coupled to the vacation packages engine 106, the preference profile module 104, the real-time package availability and price module 110, the additional parameter profile module 108, and/or the booking engine 112, such that the at least one multifactorial AI decision support algorithm may create hyper-personalized wellness travel experiences, ensuring that spa services, health retreats, and/or holistic travel topics align with the preferences and/or parameters of the at least one user. Moreover, as shown in FIGS. 5A-5H, the dynamic itinerary building, via the at least one multifactorial AI decision support algorithm, may allow service providers to create fully optimized vacation schedules, incorporating real-time availability updates, travel constraints, and/or AI-driven activity suggestions. By automating itinerary structuring, the at least one multifactorial AI decision support algorithm may ensure that users maximize their travel experience while minimizing scheduling conflicts.

Moreover, in this embodiment, the at least one multifactorial AI decision support algorithm may comprise a cross-sell functionality, such that the at least one multifactorial AI decision support algorithm of the vacation packaging configurator may identify potential add-ons, such as dining experiences and transportation services. Additionally, in some embodiments, through smart contract automation, ancillary services may be dynamically linked to primary bookings, ensuring that the at least one user may be presented with timely upsell opportunities without manual intervention.

Additionally, as shown in FIGS. 5A-5H, in conjunction with FIG. 3, in an embodiment, real-time pricing adjustments may be made possible through the at least one multifactorial AI decision support algorithm demand forecasting, allowing the system to dynamically modify bundled pricing based on behavior, availability, and/or seasonal trends of the at least one user. In addition, in this embodiment, the at least one multifactorial AI decision support algorithm may incorporate geo-targeted pricing strategies within both the vacation packages engine 106 and/or the booking engine 112, such that the vacation packages engine 106 and/or the booking engine 112 of the vacation packaging configurator 100 may adjust package pricing based on the user's physical location or region of interest. By analyzing geographic booking trends, the vacation packaging configurator 100 may apply location-based discounts and/or market-specific adjustments, ensuring that regional demand fluctuations are accommodated.

Moreover, the booking engine 112 may allow dynamic synchronization between an opaque pricing module and hotel revenue optimization tools, via the at least one multifactorial AI decision support algorithm and/or the blockchain-based transaction system. Accordingly, through blockchain-based financial reconciliation of the blockchain-based transaction system, at least one service provider may transparently track revenue sharing agreements, ensuring accurate financial reporting across multiple distribution partners.

In some embodiments, the smart contracts of the blockchain-based transaction system of the vacation packaging configurator may enforce dynamic pricing rules within the opaque pricing system, ensuring that bundled rates automatically adjust based on availability, location-based demand, and real-time market conditions, as shown in FIG. 5E-FIG. 5H. As such, pricing changes may be executed autonomously through the predefined smart contract conditions, eliminating the need for manual adjustments by service providers. In this manner, the dynamic pricing governance of the blockchain-based transaction system may ensure pricing stability, preventing unauthorized rate fluctuations or pricing inconsistencies across different platforms. Additionally, geo-targeted pricing adjustments may be recorded on the decentralized ledger, allowing providers to analyze regional booking trends while ensuring that pricing variations remain secure and/or tamper-proof. Moreover, the blockchain-based transaction system may implement the smart contracts to enforce price-matching guarantees, in real-time, automatically refunding users if a price discrepancy is detected post-booking.

As shown in FIGS. 5C-5D, in some embodiments, blockchain-based transaction system systems may be integrated with the opaque pricing module within the booking engine of the vacation packaging configurator, allowing providers to define transparent yet confidential revenue-sharing agreements between multiple service providers. As such, each revenue allocation model may be governed by smart contract automation, ensuring that predefined revenue splits occur instantly and/or without dispute when a booking is finalized. In this manner, revenue distribution records may be stored securely on the decentralized ledger, allowing for real-time financial reconciliation without relying on centralized payment processing intermediaries. Additionally, the blockchain-based transaction system may further prevent unauthorized pricing overrides, ensuring that licensees maintain full control over pricing models while reducing the likelihood of external tampering. Moreover, the decentralized financial tracking of the blockchain-based transaction system may allow service providers to access real-time reports of opaque pricing performance.

In some embodiments, opaque pricing verification smart contracts of the blockchain-based transaction system may ensure that service providers remain compliant with jurisdiction-specific pricing policies, preventing unauthorized price manipulations. As such, regulatory authorities may be granted access to the encrypted yet verifiable pricing decentralized ledger, allowing them to audit pricing compliance without exposing sensitive business strategies. In this manner, the service providers may mitigate legal risks associated with pricing discrepancies, as all package cost calculations may be permanently recorded for auditability. Additionally, the blockchain-based transaction system may implement automated refund policies, such that the at least one user may receive instant refunds and/or price adjustments when opaque pricing inconsistencies occur due to technical errors and/or regulatory infractions. Moreover, such a decentralized pricing validation model of the blockchain-based transaction system may allow service providers to maintain trust with consumers, as all pricing policies remain immutable and/or verifiable through the decentralized ledger of the vacation packaging configurator.

As shown in FIGS. 4A-6E, in conjunction with FIGS. 1-3, in some embodiments, the vacation topics import engine 102, the vacation packages engine 106, and/or the booking engine 112, via the at least one multifactorial AI decision support algorithm, may analyze user preferences, booking history, and/or real-time engagement metrics, ensuring that each vacation package recommendation may be customized to align with the traveler's unique interests. As such, the at least one multifactorial AI decision support algorithm may comprise a plurality of deep learning models which may allow real-time customization of travel packages, such that the at least one user may receive itinerary, hotel package, and/or vacation package suggestions based on individual preferences and prior interactions with the vacation packaging configurator (e.g., the preference profile module, the at least one user interface, etc.). In this manner, the deep learning modules may be predictive, such that the at least one multifactorial AI decision support algorithm may anticipate which activities, accommodations, and/or dining options the at least one user may prefer (e.g., spa outings, and/or golf courses), streamlining the booking process. Additionally, the at least one multifactorial AI decision support algorithm may comprise reinforcement learning models which may continuously refine personalization algorithms (i.e., an AI-based personalization engine), such that each iteration of the vacation packaging configurator may be more aligned with user expectations. Moreover, the at least one multifactorial AI decision support algorithm may enable service providers to aggregate external user data, ensuring that past booking experiences inform future travel recommendations.

In some embodiments, the at least one multifactorial AI decision support algorithm communicatively coupled to the at least one user interface and/or the processor of the vacation packaging configurator may also comprise a plurality of natural language processing (hereinafter “NLP”) AI models to enhance personalized user interactions, such that the at least one user may receive contextually relevant suggestions through chatbots or automated recommendations, as shown in FIG. 5C-FIG. 5D. As such, the at least one AI-driven user interface may allow the at least one user to ask specific travel-related questions, receiving tailored responses based on their historical booking data. In this manner, the vacation packaging configurator may include a plurality of AI-powered recommendation refinement engines, such that the at least one multifactorial AI decision support algorithm may adjust travel suggestions dynamically, allowing the at least one user to receive updated vacation package options as they refine their search criteria. Additionally, deep-learning-driven semantic analysis by the at least one multifactorial AI decision support algorithm may detect nuances in user preferences, ensuring that recommended vacation options align closely with their needs. Moreover, the at least one multifactorial AI decision support algorithm may further include a plurality of AI-powered voice recognition models which may enable the at least one user to search for vacation packages using voice commands, ensuring a seamless, hands-free booking experience.

In some embodiments, the at least one multifactorial AI decision support algorithm may comprise a plurality of AI-enhanced itinerary generation models configured to optimize travel scheduling, such that the at least one user may receive vacation, hotel, and/or itinerary suggestions that minimize downtime and/or maximize enjoyment. As such, the at least one multifactorial AI decision support algorithm may ensure that activity scheduling aligns with preferred time slots, proximity between attractions, and/or user-defined constraints. In this manner, the at least one multifactorial AI decision support algorithm may be configured to be trained, via at least one deep-learning database within at least the memory of the vacation packaging configurator and/or the at least one third-party server communicatively coupled to the vacation packaging configurator, on previous booking history of the at least one user and/or at least one alternative user, browsing patterns of the at least one user and/or at least one alternative user, and/or preference selections of the at least one user and/or at least one alternative user. In this manner, the reinforcement learning-based itinerary optimization models may allow the vacation packaging system (e.g., the at least one multifactorial AI decision support algorithm) to learn from past traveler experiences, refining suggestions for future users with similar travel preferences. Additionally, in these other embodiments, the at least one multifactorial AI decision support algorithm may have a plurality of AI-powered calendar synchronizing models, such that booked vacation schedules may be integrated with a personal digital calendar of the at least one user, providing easy access to reservation details of the hotel package and/or vacation package by the at least one user. Moreover, in these other embodiments, the at least one multifactorial AI decision support algorithm may comprise a plurality of AI-driven dynamic rebooking assistance models communicatively coupled to the vacation packages engine and/or the booking engine, such that the vacation packaging configurator may automatically offer alternative itinerary suggestions, in real-time, in cases where selected activities and/or accommodations become unavailable.

In some embodiments, the at least one multifactorial AI decision support algorithm may also comprise a plurality of AI-powered sentiment analysis models, such that the at least one multifactorial AI decision support algorithm may be configured to monitor user feedback, social media trends, and/or online reviews, allowing the vacation packaging configurator to verify that any provided recommendations align with real-world satisfaction levels, in real-time. As such, in these other embodiments, the at least one multifactorial decision support may extract insights from millions of traveler reviews, ensuring providers to prioritize vacation packages with high user satisfaction ratings. In this manner, a plurality of AI-driven emotion recognition models of the at least one multifactorial AI decision support algorithm may refine hotel and activity recommendations of service providers, such that the at least one user may receive suggestions that best match their emotional preferences, via the at least one user interface of the vacation packaging configurator. Additionally, the plurality of AI-powered visual sentiment analysis models may also analyze user-uploaded vacation images, verifying that recommended experiences are based on authentic traveler insights rather than promotional material alone. Moreover, machine learning-based trend detection models of the at least one multifactorial AI decision support algorithm may further identify emerging travel destinations, allowing service providers to recommend new vacation opportunities before they become mainstream.

As shown in FIGS. 5A-5H, in conjunction with FIGS. 1-3, in some embodiments, the at least one multifactorial AI decision support algorithm may continuously refine opaque pricing structures, allowing the system to determine the most effective bundling configurations for different hotel packages and/or vacation packages. As such, the multifactorial AI decision support algorithm may comprise a plurality of AI-driven pricing segmentation models configured to customize package offerings based on regional demand, traveler demographics, and/or past purchasing behaviors. In this manner, the at least one multifactorial AI decision support algorithm may also allow real-time adjustments to opaque pricing conditions, such that that each bundled package may remain optimized for profitability and/or conversion rates. Additionally, the machine learning and/or deep learning reconstruction deterrence models of the at least one multifactorial AI decision support algorithm may prevent users from reverse-engineering opaque price structures, concealing individual component costs of the hotel package and/or vacation package. Moreover, in these other embodiments, the at least one multifactorial AI decision support algorithm may include a plurality of AI-powered profit margin optimization models, allowing service providers to fine-tune price variations, such that that adjustments may not negatively impact long-term revenue performance.

In some embodiments, the AI-powered user profiling models of the vacation packaging configurator may personalize opaque pricing strategies, ensuring that each traveler receives customized package pricing based on real-time engagement metrics. As such, the at least one multifactorial AI decision support algorithm may be configured to segment users based on booking frequency, spending habits, and/or preferred vacation types, such that the vacation packaging configurator may offer dynamic discounts and/or exclusive upsell opportunities. In this manner, the personalized pricing models may also provide context-aware promotions, such that the at least one user may receive individualized pricing that maximizes the likelihood of booking completion. Additionally, predictive analytics may also enable real-time A/B testing of pricing structures, such that service providers can assess which pricing strategies result in higher conversion rates. Moreover, machine learning models of the at least one multifactorial AI decision support algorithm may analyze cross-platform booking behaviors, ensuring that opaque pricing remains consistent across multiple distribution channels.

In some embodiments, the deep learning-based multifactorial AI decision support algorithm may analyze macroeconomic conditions, seasonal fluctuations, and/or emerging travel trends. As such, the opaque pricing strategies may remain aligned with global market dynamics. In these other embodiments, demand forecasting models may be integrated within the at least one multifactorial AI decision support algorithm, such that the vacation packaging configurator may predict which vacation destinations will experience high traffic in upcoming months, allowing providers to adjust package pricing preemptively. In this manner, machine learning-powered adaptive pricing strategies of the vacation packaging configurator may allow service providers to configure opaque pricing rules dynamically. Maximum profitability may be ensured while maintaining competitive pricing. Additionally, AI-based real-time competitor pricing analysis may allow service providers to benchmark their pricing models against rival platforms, Moreover, the at least one vacation packaging configurator may comprise at least one AI-driven market sensitivity simulation to allow service providers to test different price point scenarios, ensuring that adjustments are optimized for both short-term and long-term revenue stability.

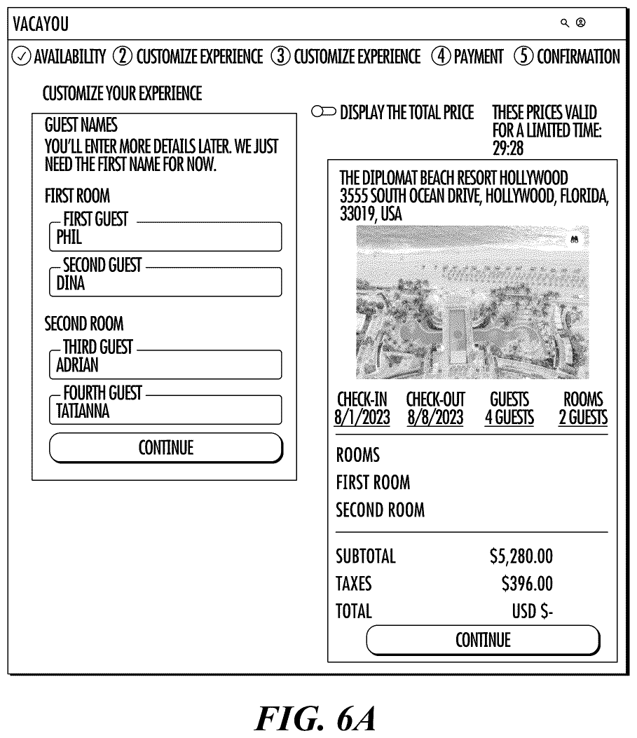

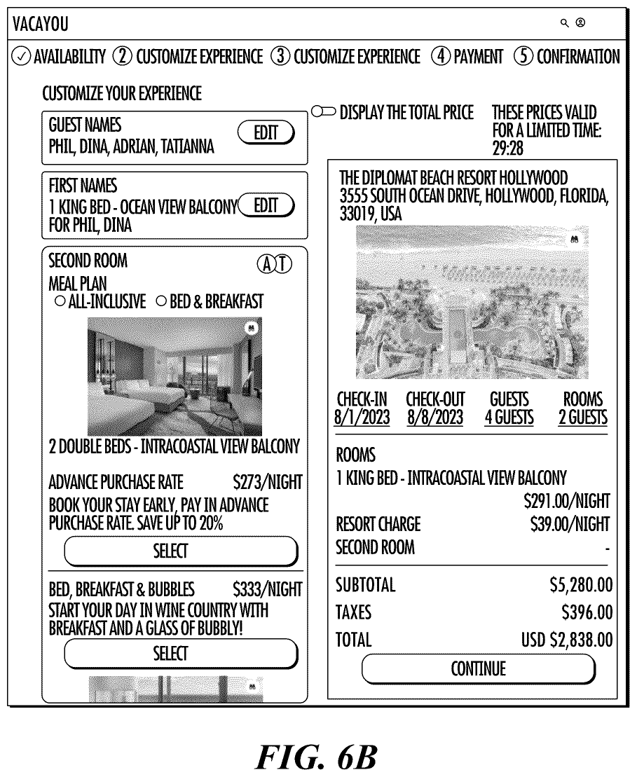

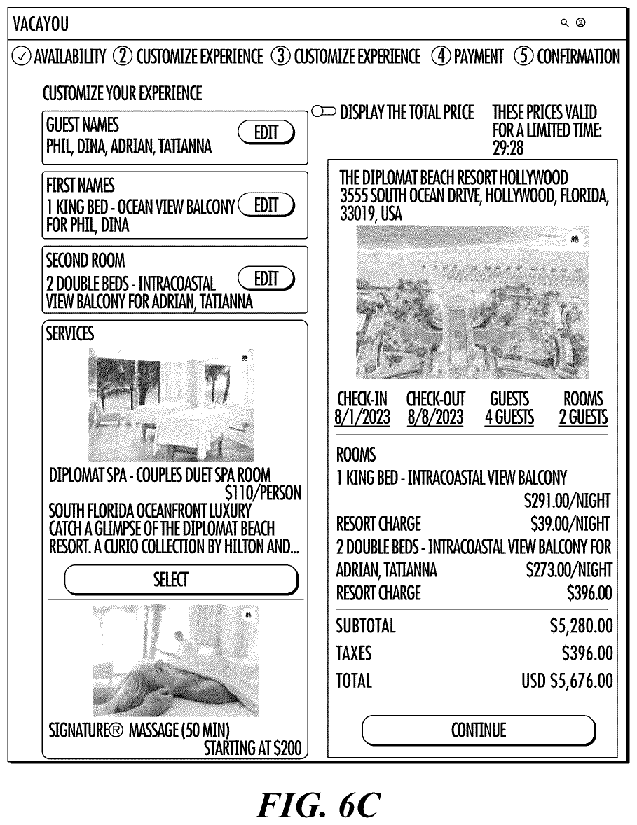

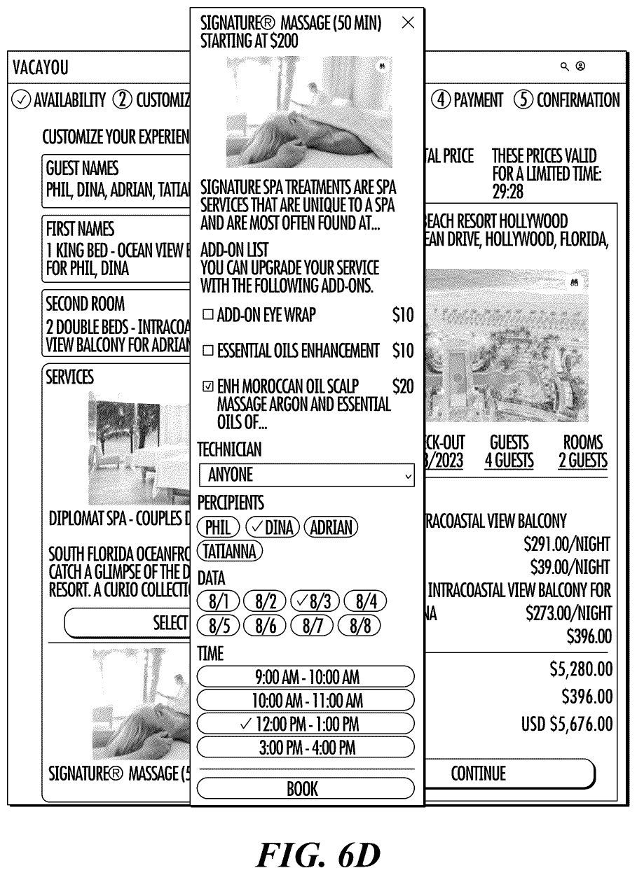

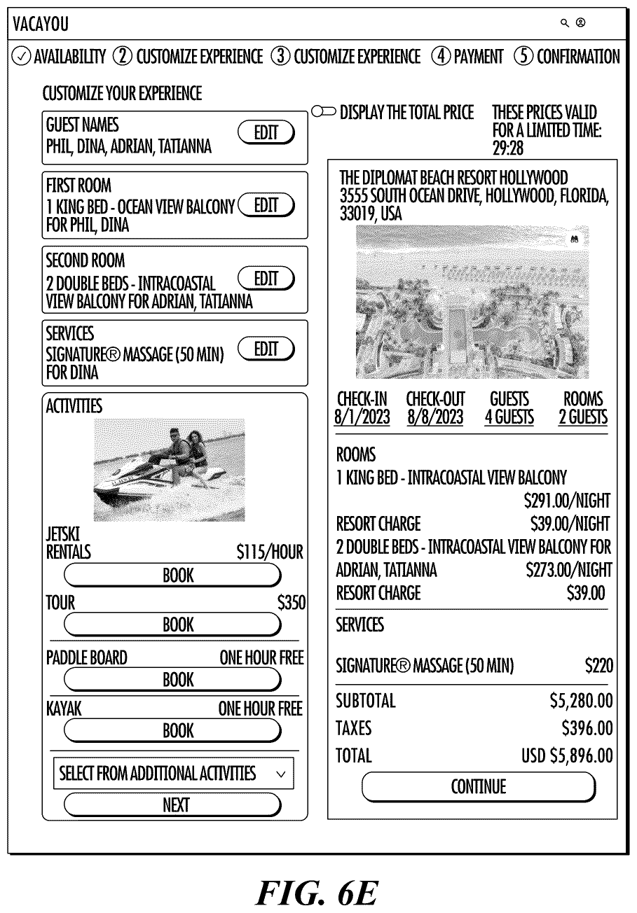

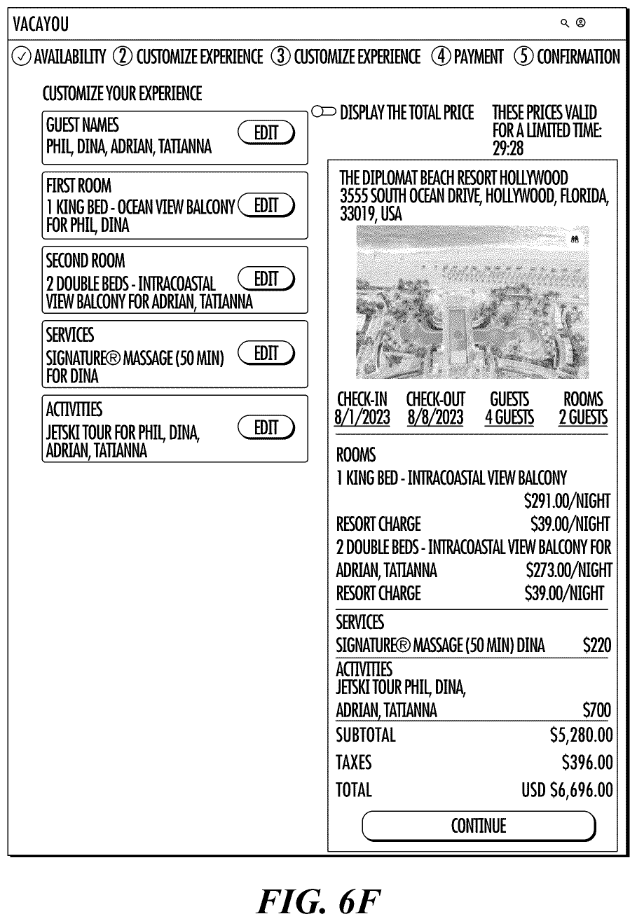

Furthermore, another aspect of the present disclosure pertains to customizing either the vacation package or the property package within the vacation packaging configurator, as shown in FIGS. 6A-6F. In this manner, as shown in FIGS. 6A-6F, in conjunction with FIGS. 3-5H, in an embodiment, once the user has selected the at least one wellness experience and/or the at least one property, within either the vacation package or the property package, the vacation packaging configurator may be provided to present a customizable module, such that the user may select at least one alternative aspect within the at least one wellness experience and/or the at least one property. As such, as shown in FIG. 6A, within the customizable module, the vacation packaging configurator may present the user with a guest button. Accordingly, within the guest button, the user may then assign and/or identify each option of the at least one wellness experience, and/or at least one room of the property to the user, at least one guest, and/or at least one alternative guest. For example, in some embodiments, when the user selects two rooms within the at least one property package, the customizable module of the vacation packaging configurator may be presented to the user, such that they may assign the first room to the user and/or at least one guest and/or the second room to the at least one guest.

Additionally, as shown in FIG. 6B, in an embodiment, the customizable module may be configured to allow the user, via the at least one user interface communicatively coupled to the computing device in association with the vacation packaging configurator to edit and/or amend the at least one option of the at least one wellness experience and/or at least one property, within the guest button. In this manner, the vacation packaging configurator may provide at the recommended option based on preference profile 104 of the user, as stated above, in addition to at least one alternative option which the user and/or the at least one guest may select based on their individual preference. In this embodiment, the customizable module may be configured to provide the real time price (e.g., $500/night and/or $5000/predetermined duration of time) of the recommended option and/or the at least one alternative option of the at least one wellness experience and/or the at least one property. For example, as shown in FIG. 6B, in this embodiment, when the user and/or the at least one guest is selecting a room within the at least one property, the customizable module may be configured to present on a module the recommended room and/or at least one alternative room within the at least one property. In this manner, the at least one alternative room may be ranked from most similar to preference profile 104 to least similar in a top-down formation. Furthermore, in this example, once the user has selected their room, the at least one guest may then select their room within a separate selection button, such that the user selection button is minimized optimizing space on the customizable module, such that the at least one guest may easily visualize each property option available. As such, in some embodiments, the customizable module may be configured to allow the user to select both the at least one option of the at least one wellness experience and/or the at least one property for both the user and the at least one guest.

In addition, in an embodiment, as shown in FIGS. 6C-6D, the customizable module may be configured to provide at least one additional and/or at least one alternative option to the user, such that user may add and/or replace at least one option within the vacation package and/or the property package with at least one additional wellness experience and/or at least one alternative wellness experience for the user and/or the at least one guest. In this embodiment, as shown in FIGS. 6C-6D, the customizable module may be configured to provide at a service button, such that the service button is highlighted when selected, providing additional aspects of the at least one wellness experience, including but not limited to additional add-on aspects of the wellness experience to include and/or at least one alternative aspect of the wellness experience to change from the original vacation package and/or property package. In this manner, the service button may also comprise a section, such that the user and/or the at least one guest may select a specified technician and/or expert related to the at least one wellness experience and/or any technician and/or expert available.

In addition, as shown in FIGS. 6C-6D, in this embodiment, the customizable module may comprise at least one additional section, such that the user may select which individual (e.g., the user and/or the at least one guest) is going to participate in the at least one add-on aspect and/or alternative aspect of the at least one selected wellness experience. Moreover, as shown in FIGS. 6C-6D, in conjunction with FIG. 3, in this embodiment, the service button may further comprise at least one section to determine which date and/or time within the predetermined date range, as determined by availability and preference profile 104 of the user, the at least one additional add-on aspect and/or the at least one alternative aspect of the at least one wellness experience may take place within the vacation package and/or the property package. Furthermore, the service button may comprise a booking button, such that vacation packaging configurator may automatically update the real-time price of the overall selected vacation package and/or property package based on the additional and/or new price provided by the at least one add-on aspect and/or the at least one alternative aspect, respectively, of the at least one wellness experience.

FIG. 6E depicts the customizable module comprising an activities button in communication with at least one third-party software, program, and/or computing device, via any booking API known in the art, according to an embodiment of the present disclosure. In this embodiment, the customizable module may provide the user with the activities button, such that the user may select at least one additional wellness experience available from the at least one selected property and/or at least one third-party wellness experience provider within a predetermined distance from the selected property of the vacation package and/or the property package. In some embodiments, the at least one third-party wellness experience provider may be associated with the at least one wellness experience and/or the at least one property, such that the vacation packaging configurator may provide deals and/or reduced pricing on the at least one wellness activity within the activities button. In this manner, if the third-party wellness experience provider is not associated with the at least one selected property, the full-real time price of the wellness experience within the activities button may be provided, via API. For example, as shown in FIG. 6E, in some embodiments, the activities button may comprise jet ski rentals and/or tours, paddle boards, and/or kayaks. In this example, the activities module may provide real-time pricing of the at least one wellness experience, and/or may show that the real-time pricing has been reduced, via verbal and/or visual communication (e.g., a line through the original pricing with the discounted pricing available in red adjacent to the original pricing). Furthermore, in some embodiments, at least one wellness activity within the activities button may be no additional charge if they are originally provided by the at least one selected property and/or if the at least one selected property has provided a discount based on the relationship between the at least one selected property and/or the third-party wellness provider, vice versa, and/or based on the type of vacation package and/or property package selected by the user.

As shown in FIGS. 6E-6F, in conjunction with FIGS. 1-3, in embodiments, the vacation packaging configurator may integrate directly with third-party Point-of-Sale (hereinafter “POS) systems (e.g., Spa POS systems and Golf TeeSheet technology), ensuring that the user may access live, real-time availability for a plurality of wellness experience (e.g., spa treatments and tee times) at the time of vacation package selection and/or checkout. As such, the processor and/or the vacation packaging engine of the vacation packaging configurator may communicate via an API-driven synchronization module and/or the ARI-driven synchronization module within the vacation packaging engine and/or the booking engine, which may retrieve available appointment slots from the respective external systems and/or display them within the user interface of the vacation packaging configurator. In this manner, in these other embodiments, the user, via the at least one user interface may be able to select and/or confirm appointments within their vacation package without requiring secondary verification from the administration and/or third-party associated with the at least one wellness experience (e.g., spa or golf course administration). Additionally, the integration of the API-driven synchronization module may enable dynamic updates to availability, preventing situations where the at least one user may select time slots that may have already been booked through external channels. Moreover, the direct synchronization of the vacation packaging configurator with external POS systems may ensure that once a booking is confirmed, the appointment may be reflected in both the vacation packaging configurator and the provider's internal reservation system.

Moreover, in embodiments, the vacation packaging configurator may also retrieve real-time inventory across multiple service providers, displaying available spa treatments and tee times within the same booking selection flow. In these embodiments, rather than relying on static availability lists or pre-reserved slots, the vacation packaging configurator, via the vacation engine and/or the booking engine, in conjunction with the at least one multifactorial AI decision support algorithm, may actively check each POS system before presenting available time options. In this manner, the real-time availability verification process may reduce overbooking errors while ensuring that user always receive up-to-date service selections. Additionally, in these embodiments, because the vacation packaging system may integrate directly with third-party inventory tracking modules, it may allow wellness experience facilities (e.g., spa and/or golf facilities) to dynamically update available slots without manual input from hotel and/or resort administrators. Moreover, the vacation packaging configurator may utilize machine-learning-based demand forecasting models within the vacation packaging engine and/or the booking engine to predict when high-demand times are likely to sell out, allowing automated prioritization of alternative availability options within the booking process.

As shown in FIGS. 6E-6F, in conjunction with FIGS. 1-3, in embodiments, the vacation packaging configurator may enable multi-service coordination, ensuring that the at least one wellness experience (e.g., spa appointments and golf tee times) may be structured around other vacation packaging components and/or topics. As such, the vacation packaging system may prevent scheduling conflicts by cross-referencing activity durations, travel buffer times, and/or the itinerary preferences of the user before finalizing bookings. In this manner, the user may receive an optimized schedule without requiring manual adjustments after checkout. Additionally, the vacation packaging configurator may also be configured to allow for advanced reservations, enabling users to book services months in advance while ensuring that availability remains accurate at the moment of selection. Moreover, For example, for resorts with multiple spa and golf locations, in embodiments, the vacation packaging configurator may automatically suggest the most convenient and/or preferred locations based on real-time occupancy levels and preferences of the user, via the API-driven synchronization module within the vacation packaging engine and/or the booking engine of the vacation packaging configurator.

Additionally, as shown in FIGS. 6E-6F, in conjunction with FIGS. 1-3 and FIG. 7, in embodiments, the vacation packaging configurator may allow the user to complete the entire wellness experience and/or vacation packaging booking process (e.g., spa and/or golf booking process) online, eliminating the need for manual confirmations, follow-up calls, and/or email exchanges. As such, the vacation packaging configurator may synchronize the appointment selection directly with the external POS system, via the API-driven synchronization module and/or the ARI-driven synchronization module, confirming the booking at the time of checkout rather than requiring a separate verification step. In this manner, the vacation packaging configurator may transmit immediate confirmation to the user, executed by the processor, of the preferred wellness experiences and/or vacation package without waiting for a third-party representative (e.g., a hotel representative and/or a resort representative) to manually process the request. Additionally, in embodiments, subsequent to the user selecting a wellness experience (e.g., a spa appointment or tee time), the vacation packaging configurator may automatically update the internal system of the service provider, via the API-driven synchronization module and/or the ARI-driven synchronization module of the vacation packaging engine and/or the booking engine of the vacation packaging configurator, such that no duplicate booking attempts may occur. Moreover, the absence of manual processing steps may improve operational efficiency for resorts, reducing staff workload and guest wait times.

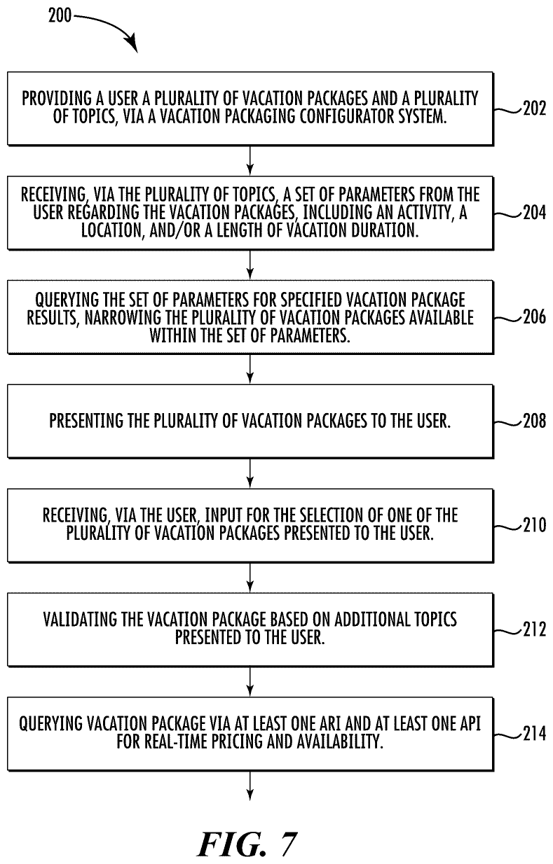

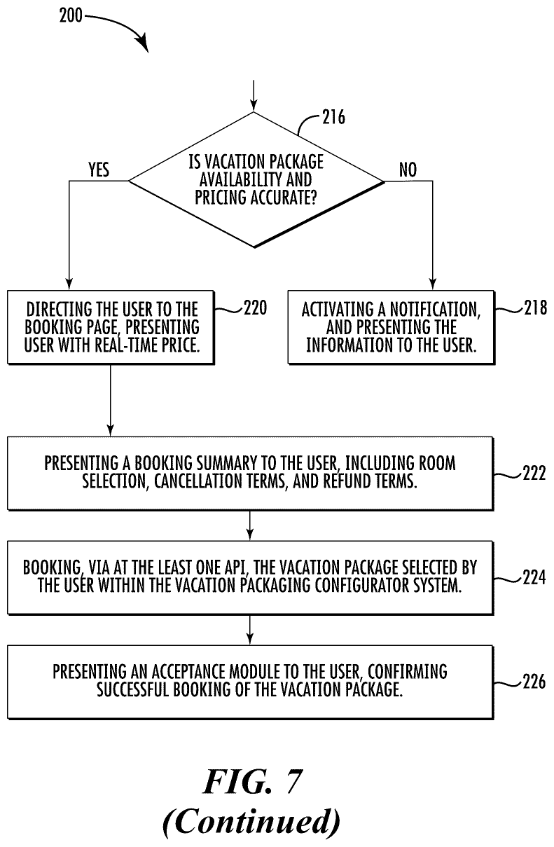

In addition, as shown in FIG. 7, in conjunction with FIGS. 4A-6F, in embodiments, the vacation packaging configurator may also be configured to generate automated confirmations upon successful reservation processing, ensuring that the user may receive an instant digital itinerary. As such, upon finalizing a booking, the booking engine of the vacation packaging configurator may transmit an electrical signal to the processor, such that the processor of the vacation packaging configurator may transmit a structured confirmation email that each wellness experience and/or hotel appointment/booking, including but not limited to spa and/or golf appointment details, such that the user may have all relevant information before their arrival. In this manner, in embodiments, the at least one multifactorial AI decision support algorithm may comprise a plurality of AI-driven itinerary verification modules configured to validate that no conflicting activities have been scheduled, prompting the user to make changes prior to finalizing their package selection. Additionally, in embodiments, if any service provider implements last-minute changes to their schedule, the vacation packaging configurator may proactively notify affected users and/or offer alternative time slots, executed by the processor of the vacation packaging configurator. Moreover, the vacation packaging configurator may also be configured to integrate real-time chatbot and/or virtual assistant features (i.e., a popup packaging widget (described further below)), allowing the user to make modifications without requiring direct human assistance.

Furthermore, as shown in FIG. 6F, in an embodiment, when the user has selected all options within the customizable module, the vacation packaging configurator may be configured to automatically provide an updated real-time price based on the options selected by the user within the customizable module. As such, the customizable module may provide an updated total cost and/or travel itinerary based on the at least one selected option within the customizable module, such that the vacation packaging configurator may provide the updated total cost and/or travel itinerary to the user via the display device and/or the at least one user interface (e.g., graphical user interface) communicatively coupled to the computing device in association with the vacation packaging configurator. In this manner, once the user has received the updated real-time total cost and/or travel itinerary, the vacation packaging configurator may be configured to provide a highlighted button within the customizable module, such that once selected the user may continue to the user information module, as shown in FIG. 5F.

In an embodiment, as shown in FIGS. 6A-6F, in conjunction with FIG. 3, the vacation packages engine 106 of vacation packaging configurator 100, may further comprise a popup packaging widget. In this embodiment, the popup packaging widget may be designed to enhance user engagement by presenting real-time dynamic package options based on availability and/or preferences and/or parameters of the at least one user. As such, when the at least one user browses specific vacation offerings, the vacation packaging configurator may detect browsing patterns, via the at least one multifactorial AI decision support algorithm and/or trigger a relevant package recommendation via a popup of the popup packaging widget, reducing the likelihood of users navigating away before completing a booking. In this manner, in this embodiment, the popup packaging widget may increase upsell conversions by presenting contextually relevant package deals during the user's booking journey, via the at least one ARI and/or API communicatively coupled to the processor of the vacation packaging configurator.

Additionally, as shown in FIGS. 6D-6F, in an embodiment, behavioral triggers may be implemented by the popup packaging widget communicatively coupled by the at least one multifactorial AI decision support algorithm, to optimize engagement, ensuring that the popup of the popup packaging widget may be displayed only when the user has shown clear intent to browse a package. As such, the AI-driven predictive modeling of the at least one multifactorial AI decision support algorithm may analyze session duration, past booking patterns, and/or browsing history to ensure the popup of the popup packaging widget may be presented at the most strategically beneficial moment.

In addition, in an embodiment, the popup widget may integrate seamlessly with third-party service providers (e.g., hotel and activity providers) platforms. The lightweight API architecture (i.e., the API-driven synchronization module) may allow at least one service provider to incorporate the popup packaging widget with minimal development effort, reducing integration costs and/or technical complexity. Moreover, in this embodiment through smart contract automation, service providers (e.g., hotels and/or resorts) may dynamically generate time-sensitive promotions tied to specific booking conditions, ensuring automated execution of limited-time offers.

As shown in FIGS. 5A-6F, in conjunction with FIG. 3 and FIG. 7, in embodiments, the system may implement dynamic package adjustment features, allowing guests to modify their spa or golf reservations based on real-time availability updates. For example, if a previously selected time slot for a wellness experience becomes unavailable, the vacation packaging configurator may automatically prompt the user to choose an alternative appointment before proceeding to checkout, via the packaging popup widget. In this manner, in embodiments, the vacation packaging configurator may always transmit a confirmed selection to the user, preventing unexpected disruptions during their stay. Additionally, in embodiments, the vacation packaging configurator may prioritize preferred availability windows, via the popup packaging widget, in tandem with the ARI-driven synchronization module and/or the API-driven synchronization module, ensuring that the user may receive optimized scheduling options rather than generic replacements. Moreover, the vacation packaging engine and/or the booking engine of the vacation packaging configurator may allow for same-day modifications, enabling users to shift appointments based on personal itinerary changes or unexpected conflicts, executed by the ARI-driven synchronization module and/or the API-driven synchronization module.

As shown in FIGS. 6A-6F, in conjunction with FIG. 3 and FIG. 7, in some embodiments, the blockchain-based transaction system may be communicatively coupled to the popup packaging widget to ensure the authenticity and/or verifiability of displayed package deals on the at least one user interface of the vacation packaging configurator. As such, each package offer may be generated using a blockchain-verified pricing model, preventing fraudulent pricing manipulations by unauthorized third-party service providers. In this manner, package transparency may be improved, as the at least one user may verify that dynamic package deals have not been altered mid-transaction, via the at least one user interface. Additionally, in these other embodiments, the blockchain-based transaction system may further comprise smart contract-enforced package expiration rules, such that the blockchain-based transaction system may prevent the at least one user from exploiting outdated promotional pricing, ensuring that only currently active offers remain accessible. Moreover, the decentralized blockchain ledger of the blockchain-based transaction system may also store all historical package data, allowing service providers to analyze promotion performance trends based on immutable transaction records.

In these other embodiments, the smart contract mechanisms of the blockchain-based transaction system may be used to trigger popup offers dynamically, via the popup packaging widget, ensuring that customized vacation deals are only displayed when specific user behaviors are detected. As such, the smart contracts may autonomously execute user engagement rules, determining when upsell promotions should appear based on real-time browsing data stored on a decentralized ledger. In this manner, the popup packaging widget may become more responsive to interactions by the at least one user, displaying only the most relevant ancillary services at optimal decision-making points. Additionally, service providers and/or the vacation packaging configurator may configure blockchain-based engagement algorithms in tandem with the at least one multifactorial AI decision support algorithm, via the processor, in order to ensure that the popup packaging widget may adhere to predefined marketing triggers without requiring manual oversight. Moreover, the smart contract-based engagement models of the blockchain-based transaction system may allow automatic rewards or discounts to be applied when a user books a specific number of additional package components.

In some embodiments, the blockchain-based transaction system may improve the credibility and/or security of third-party package integrations, ensuring that service providers can verify package authenticity before presenting them via the popup packaging widget. As such, in these other embodiments each third-party package listing may be registered on the decentralized ledger of the blockchain-based transaction system, allowing the system to cross-check its authenticity before displaying it to users. In this manner, fraudulent and/or counterfeit package offerings may be eliminated, ensuring that only verified and/or validated vacation deals may be presented by the vacation packaging configurator, via the at least one user interface. Additionally, the smart contracts may enable service providers, via the vacation packaging engine and/or the booking engine to define contractual terms regarding package visibility duration, discount thresholds, and/or user engagement conditions without requiring constant manual adjustments. Moreover, in these other embodiments, the blockchain-based transaction system, via the processor and/or the at least one multifactorial AI decision support algorithm communicatively coupled to the at least one ARI and/or API, may allow automated regulatory compliance tracking, ensuring that displayed vacation deals adhere to jurisdiction-specific pricing regulations.

In some embodiments, blockchain-based incentive programs may be incorporated into the popup packaging widget, allowing users to earn tokenized rewards (e.g., Cryptocurrency and/or NFTs) for engaging with specific travel packages. As such, the at least one user who explores multiple package options within the widget may accumulate loyalty tokens, which may later be redeemed for exclusive vacation discounts, via the blockchain-based transaction system. In this manner, the NFT-based reward system of the blockchain-based transaction system may be deployed, where the at least one user may receive digital travel vouchers that unlock premium vacation benefits upon redemption. Moreover, service providers may use these blockchain-powered loyalty models of the blockchain-based transaction system of the vacation packaging configurator to encourage return bookings, ensuring continuous customer engagement within the ecosystem of the vacation packaging configurator.

Furthermore, as shown in FIGS. 6A-6F, in conjunction with FIG. 3 and FIG. 7, in some embodiments, the blockchain-based transaction system may comprise opaque pricing models may be deployed to enhance pricing security, prevent rate manipulation, and ensure revenue transparency. As such, each bundled package price may be cryptographically hashed and/or stored on the decentralized ledger of the blockchain-based transaction system, ensuring that individual component costs remain confidential while maintaining verifiable pricing integrity. In this manner, users may be prevented from reverse-engineering package pricing, as only the final bundled rate may be displayed via the at least one user interface and/or the booking engine and/or the vacation packages engine. Additionally, blockchain smart contracts may be configured to automatically update pricing structures in real-time based on demand fluctuations, service provider-defined revenue strategies, and/or user behavior trends. Moreover, in these other embodiments, the blockchain-based transaction system may allow third-party auditors to verify opaque pricing adherence, ensuring that service providers comply with industry-standard pricing regulations without exposing their proprietary pricing models.

In some embodiments, the vacation packaging configurator may ensure that every booked wellness experience of the vacation package (e.g., spa and/or golf appointment) receives a confirmation number, which may be recorded in both the memory of the vacation packaging configurator and/or a third-party server (e.g., the provider's POS system), via the processor of the vacation packaging configurator. As such, the blockchain-based transaction module may ensure that confirmed appointments cannot be altered, double-booked, and/or lost, unless canceled through by an administrator. In this manner, in these other embodiments, the at least one multifactorial AI decision support algorithm may enhance system reliability, such that that all user selections may be securely stored and/or retrievable. Additionally, in these other embodiments, the vacation packaging configurator may generate automatic reminders, alerting users of their upcoming wellness experience (e.g., spa or golf bookings) via email, text, mobile push notifications, and/or any notification mechanism known in the art. Moreover, if a guest cancels and/or modifies a service, the vacation packaging configurator may immediately update the associated service provider, such that the time slot may be automatically reopened for at least one alternative user in real time.

Moreover, in an embodiment, the AI-driven personalized recommendations of the multifactorial AI decision support algorithm, via the popup packaging widget of the vacation packaging configurator, may analyze user behavior, such that each package offerings may be tailored to the at least one user accordingly. In this manner, by utilizing machine learning algorithms, the popup packaging widget may continuously refine its package recommendations based on evolving user behavior trends, ensuring that every displayed package aligns with current interests of the at least one user and/or booking history.

In some embodiments, the AI-driven behavioral analysis of the at least one multifactorial AI decision support algorithm of the vacation packaging configurator may optimize the activation of the popup packaging widget, such that the popup packaging widget may display promotional offers at the most effective engagement points. As such, the machine learning models may evaluate user session data, engagement rates, and/or dwell times, triggering popups only when users show high intent to book a package. In this manner, the at least one multifactorial AI decision support algorithm may prevent popup fatigue. Additionally, in these other embodiments the AI-powered A/B testing models may further analyze different popup display variations, identifying which formats generate higher conversion rates based on historical user response data. Moreover, the real-time AI analytics may enable dynamic popup content adaptation, verifying that only the most relevant package recommendations are displayed to users.

In some embodiments, the NLP AI models of the at least one multifactorial AI decision support algorithm may enable conversational popup interactions, allowing users to engage with chatbot-driven package suggestions in real-time. As such, the popup packaging widget may comprise an AI-powered virtual assistant, via the at least one multifactorial AI decision support algorithm, such that the AI-powered virtual assistant may guide users through package selection, answering queries regarding pricing, itinerary details, or customization options. In this manner, NLP-based interactive popups may increase engagement rates by offering contextual responses tailored to each user's unique needs. Additionally, the sentiment analysis models may also be configured to monitor user interactions, adjusting conversational tones and response structures to align with the user's mood and intent. Moreover, in these other embodiments, AI-enhanced text summarization models may condense complex package descriptions into digestible insights.

In some embodiments, the AI-based predictive analytics of the vacation packaging configurator may enhance the package recommendation accuracy of the popup packaging widget, ensuring that popups suggest highly relevant offerings based on user behavior and preferences. As such, the reinforcement learning models of the at least one multifactorial AI decision support algorithm may continuously refine vacation suggestions, adapting recommendations in real-time based on click-through rates, previous bookings, and/or user interactions. In this manner, the AI-driven engagement scoring algorithms may determine which package variations are most likely to appeal to a given user segment, prioritizing high-converting vacation bundles. Additionally, in these other embodiments, the AI-powered multivariate testing may also allow automated optimization of popup positioning, timing, and design, allowing each display instance to be calibrated for maximum engagement. Accordingly, real-time feedback loops may enable the popup packaging widget to self-adjust based on emerging user trends, ensuring that displayed package options remain dynamic and/or contextually relevant.

In some embodiments, AI-powered vision models may enhance the popup widget's visual content selection, such that that any displayed image and/or media may be optimized for engagement. In these other embodiments, the AI-powered image recognition models of the at least one multifactorial AI decision support algorithm may evaluate color composition, content structure, and/or visual appeal, selecting the most engaging visuals to accompany vacation recommendations. As such, the plurality of machine learning-based predictive engagement models may determine which image styles resonate best with different demographic segments, tailoring each popup for optimal response by the at least one user. Additionally, AI-driven video summarization tools may allow promotional popups to include brief, auto-generated video snippets showcasing vacation highlights, further enhancing user interest. Moreover, real-time AI feedback mechanisms may continuously optimize multimedia selection.

In some embodiments, as disclosed above, the vacation packaging configurator may comprise AI-powered API and/or ARI management components (i.e., the API-driven synchronization module and/or the ARI-driven synchronization module) to enable seamless third-party integration while ensuring optimal performance and security, via the API and/or ARI (e.g., the API-driven synchronization). As such, AI-driven API and/or ARI management components may continuously analyze traffic loads, error rates, and/or latency issues, automatically optimizing performance by allocating additional resources and/or rerouting requests dynamically. In this manner, the machine learning-based multifactorial AI decision support algorithm may flag suspicious API usage patterns, such that unauthorized access attempts may be blocked before security breaches occur. Additionally, the AI-powered API and/or ARI management components may further comprise a plurality of predictive analytics models to allow real-time optimization of API and/or ARI rate limits, such that that service providers may receive fair and/or efficient API and/or ARI access without bottlenecking critical functions. Moreover, AI-powered adaptive API and/or ARI documentation tools of the vacation packaging configurator may personalize technical guidance based on an integration requirement of the service provider, reducing onboarding time for potential software developers of the service provider.

In some embodiments, the vacation packaging configurator may comprise AI-driven white-label customization engines to allow hotels, resorts, and/or third-party partners to configure the platform and/or the at least one user interface of the vacation packaging configurator based on the brand identity and/or operational needs of the service providers. In these other embodiments, the plurality of deep learning models may analyze a branding element of the service providers, automatically recommending design modifications that align with color schemes, typography, and/or user experience standards. In this manner, AI-powered UI/UX optimization models may also be integrated within the vacation packaging configurator, via the processor, to generate automated layout recommendations, such that the at least one user interface design may maximize user engagement while maintaining brand consistency. Additionally, the plurality of reinforcement learning models may adjust platform layouts dynamically, allowing the most frequently accessed modules to receive priority placement based on historical user interactions. Furthermore, int these other embodiments, the vacation packaging configurator may comprise AI-enhanced brand compliance auditing may verify that service provider modifications adhere to pre-established customization policies, ensuring uniformity across multi-location businesses.

In some embodiments, the AI-based personalization engine of the at least one multifactorial AI decision support algorithm may comprise a plurality of AI-powered cross-sell recommendation models to optimize upselling opportunities by dynamically suggesting additional vacation add-ons, ensuring that package personalization remains seamless. The deep learning-based multifactorial AI decision support algorithm may analyze user preferences, past purchase behavior, and/or real-time engagement metrics, ensuring that cross-sell offers align with traveler interests. In this manner, machine learning-driven predictive conversion models may determine which upsell options have the highest likelihood of being accepted, such that travelers may receive curated upgrade opportunities without unnecessary distractions. Additionally, AI-powered pricing optimization models may adjust add-on costs dynamically, allowing the cross-sell offers to remain competitive while maximizing revenue potential. Moreover, the plurality of reinforcement learning models may continuously refine upselling strategies, such that service providers may maximize ancillary revenue without overwhelming users with excessive promotions.

In some embodiments, AI-enhanced revenue insights dashboards may provide licensees with real-time financial reporting and business intelligence, ensuring that vacation package performance is continuously optimized. In this manner, the AI-powered revenue forecasting models may predict booking trends based on historical sales data, seasonality, and/or macroeconomic factors, allowing providers to adjust pricing and inventory accordingly. As such, machine learning-driven fraud detection algorithms communicatively coupled to the booking engine of the vacation packaging configurator may monitor suspicious financial transactions, preventing fraudulent chargebacks or unauthorized modifications to vacation package pricing. In addition, in these other embodiments, AI-powered sentiment analysis models may also analyze traveler reviews and/or feedback, such that revenue optimization strategies may align with user satisfaction trends. Moreover, deep learning-based business intelligence models may also allow providers to benchmark their performance against competitors, aligning the opaque pricing and/or package structures with industry best practices.

### Method of Use

FIG. 7 depicts an exemplary process flow diagram depicting a method for digitally booking a vacation package on a computing device and/or providing real-time availability and/or prices in order to aid a user's vacation booking performance. The steps delineated in FIG. 7 are merely exemplary of an order of digitally booking a vacation package on a computing device. The steps may be carried out in another order, with or without additional steps included therein.

As shown in FIG. 7, in conjunction with FIGS. 1-6F, the method 200 begins at step 202, in which the vacation packaging configurator provides the user with a plurality of vacation packages and a plurality of travel topics. In an embodiment, this step may comprise communicatively coupling with ARI and/or API within the software to search and/or cache data of the plurality of travel topics within the vacation package.

Next, at step 204, the vacation packaging configurator receives, via the plurality of travel topics, the set of parameters from the user regarding the vacation packages. In an embodiment, the set of parameters from the user may include, but is not limited to, activity, location, and/or length of vacation duration. Further, at step 206 of method 200, as shown in FIG. 7, the vacation packaging configurator may be configured to query the set of parameters for certain vacation package results that are closely related to the plurality of travel topics selected by the user. In an embodiment, at step 208, the plurality of vacation packages may be presented to the user via the interface of the computing device. In an embodiment, the plurality of vacation packages presented to the user may be automatically narrowed based on the set of parameters provided by the user.

Following presenting the plurality of vacation packages to the user, at step 210 of method 200, as shown in FIG. 7, the vacation packaging configurator may receive input for the selection of one of the plurality of vacation packages presented to the user. In this embodiment, when the user selects one of the plurality of the vacation packages, the user may be sent to the booking engine. Before the user is sent to the booking engine, at step 212, respectively, the vacation packaging configurator may be configured to present at least one additional parameters to the user to verify the availability of the vacation package to the user. In an embodiment the additional parameters may include, but not limited to, age, allergies, and/or number of users within the group selecting the vacation package.

Next, at step 214, the vacation packaging configurator may then query the vacation package via the use of the at least one ARI and/or the at least one API to collect and/or cache the most recent vacation data topic to determine the real-time pricing and/or availability of the vacation package.

Moreover, at step 216, in this embodiment, the vacation packaging configurator may compare the received real-time price and/or availability cached from the at least one ARI and/or the at least one API to the cost and/or availability originally cached from the initial search using the at least one ARI and/or the at least one API. The method then proceeds to either step 218 or step 220 depending on whether a substantial match exists between the real-time price and/or availability and/or the original price and/or availability. In some embodiments, the vacation packaging configurator may regularly update the original price at predetermined intervals to maintain accuracy of availability and rates.

Referring again to FIG. 7, during step 218, the vacation packaging configurator determines that a substantial match does not exist between the real-time price and availability of the vacation package and the original price and availability. As such, during step 218, in an embodiment, the vacation packaging configurator may execute instructions to transmit a notification indicative of the real-time price and/or available of the vacation package not matching the original price and/or availability provided by the vacation packaging configurator and/or presenting the information to the user. In some embodiments, the vacation packaging configurator in association with the computing device may verbalize and/or visualize the notification of the vacation packaging configurator on the display device and/or at least one user interface (e.g., graphical user interface) communicatively coupled to the computing device.

During step 220, the integrated vacation packaging configurator system determines that a substantial match does exist between the real-time price and availability of the vacation package and the original availability and price. Accordingly, during step 220, in this embodiment, the vacation packaging configurator may direct the user to the booking engine, such that the user may be presented with the real-time price and/or availability of the vacation package.

Next, at step 222, the vacation packaging configurator may be configured to present the user a booking summary on the booking engine, including but not limited to room selection, cancellation terms, and/or refund terms. In an embodiment, the vacation packaging configurator may automatically enter the personal and/or the payment information of the user to optimize the booking process for the user. Next, at step 224, the vacation packaging configurator automatically books the aspects of the vacation package, via at least one API, using the personal and/or the payment information of the user, increasing the efficiency of the vacation booking of the user.

Finally, the method then proceeds to step 226. At step 226, as shown in FIG. 7, in this embodiment, the vacation packaging configurator may provide the user with an acceptance module, confirming successful booking of the vacation package. In some embodiments, if an issue arises within the booking process, the vacation packaging configurator may provide the user a notification of the error, and subsequently, with several solutions to alleviate the booking issue. Additionally, in some embodiments, the notification of the error may be verbalized and/or be visualized by the vacation packaging configurator, via the display device and/or at least one user interface communicatively coupled to the computing device in association with the vacation packaging configurator. In some embodiments, the vacation packaging configurator may be configured to display and/or present the real-time pricing and/or availability of the vacation package within the booking engine to the user with a predetermined time-limit (e.g., 10 minutes), such that the user must complete the booking process and/or be presented with the acceptance module of the vacation packaging configurator within the predetermined time-limit. As such, in these other embodiments, if the user fails to complete the booking process and/or be presented with the acceptance module within the predetermined time-limit, method 200 may reset, such that the user must restart the process, starting at step 202.

In an embodiment, as shown in FIG. 7, in conjunction with FIG. 3, booking engine 112 may comprise the opaque pricing module configured to provide customized pricing strategies that bundle multiple vacation package components without revealing individual costs. As such, in this embodiment, this feature may prevent users from reconstructing a package manually, ensuring that bundled packages remain exclusive to the platform and/or the at least one user interface of the vacation packaging configurator. In this manner, the at least one multifactorial AI decision support algorithm may be communicatively coupled to booking engine 112, such that the at least one multifactorial AI decision support algorithm may comprise dynamic bundling logic to ensure that the at least one user may receive a cost-effective package deal while allowing at least one service provider to optimize profit margins based on hidden pricing structures.

As shown in FIG. 7, in conjunction with FIG. 3 and FIGS. 4A-6F, in embodiments, the real-time booking flow may provide a clear, step-by-step process for selecting a plurality of wellness experiences and/or vacation topics (e.g., spa treatments and golf tee times) within the vacation package, via the vacation package engine and/or booking engine of the vacation packaging configurator. As such, when the user navigates to the preference profile module and/or additional parameter profile module of the vacation packaging configurator, in tandem with the vacation packaging engine and/or the popup packaging widget, the vacation packaging configurator may be configured display a calendar-based selection popup, allowing the user to choose their preferred appointment times from available slots. In this manner, in embodiments, the vacation packaging configurator may enable seamless activity selection, executed via the API-driven synchronization module and/or the ARI-driven synchronization module, eliminating the need for the user to manually contact the third-party service providers and/or hotels and/or golf resorts for appointment availability. Additionally, once a time slot has been chosen, the vacation packaging configurator may verify inventory in real-time, executed via the API-driven synchronization module and/or the ARI-driven synchronization module, before the user may proceed to checkout. Moreover, this verification step may occur within milliseconds, ensuring that availability discrepancies may be resolved before the user completes their vacation package selection and/or booking process, via the vacation packaging engine and/or booking engine, respectively.

In these embodiments, the system may also include AI-powered real-time booking validation, via the at least one multifactorial AI decision support algorithm, such that the user may receive instant feedback on their selection. For example, if a chosen spa treatment or tee time is unavailable, the vacation packaging configurator may automatically suggest alternative real-time options without requiring the user to manually search for replacements. In this manner, in embodiments, the vacation packaging configurator may be configured to prevent booking disruptions, such that the user may finalize their package without unexpected scheduling errors, executed via the API-driven synchronization module and/or the ARI-driven synchronization module. Additionally, the vacation packaging configurator may allow the user to filter, via the at least one user interface, options and/or vacation topics based on service type, staff availability, and/or preferred appointment durations, providing a personalized selection experience. Moreover, the booking engine may continuously update pricing information, in real-time, ensuring that any adjustments made to service fees, discounts, and/or availability restrictions are reflected at the moment of selection

In some embodiments, the plurality of AI-powered dynamic pricing models may optimize opaque pricing strategies, such that that bundled vacation packages may remain competitive while maintaining profit margins. In this manner, the plurality of machine learning models of the at least one multifactorial AI decision support algorithm may analyze historical booking trends, competitor pricing, and/or user behavior patterns, allowing the system to adjust package pricing dynamically based on real-time market conditions. In this manner, the AI-driven price elasticity models may also be configured to predict optimal price points for the service providers to maximize revenue while maintaining engagement by the at least one user. Additionally, the at least one multifactorial AI decision support algorithm may detect and/or flag and/or notify the at least one user, via the at least one user interface, regarding irregular pricing fluctuations, preventing errors that could result in overpricing or underpricing bundled packages. Moreover, in these other embodiments, the plurality of predictive pricing models for the vacation packaging configurator may help service providers proactively adjust rates for peak and/or off-peak seasons, ensuring that pricing remains aligned with demand fluctuations.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

Liu, Yinyin, et al. Integrated Travel Platform for Personalized Trip Exploration, Planning, and Booking. US 2021/0326780 A1, United States Patent and Trademark Office, 21 Oct. 2021.

All publications, patents, and/or patent applications mentioned in this specification are herein incorporated by reference to the same extent as if each individual publication, patent, and/or patent application was specifically and individually indicated to be incorporated by reference. To the extent the publications, patents and/or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A system for structuring vacation packages, booking vacation packages, or both, the system comprising:
a processor configured to execute machine-readable instructions stored on a non-transitory computer-readable medium for vacation package structuring, booking, or both;
a vacation packaging engine, executed by the processor, wherein the vacation packaging engine is communicatively coupled to a group consisting of at least one preference profile module, at least one real-time package availability and pricing module, at least one booking engine, and a combination of thereof;
a popup packaging widget module communicatively coupled to the vacation packaging engine, wherein the popup packaging widget module retrieves at least one vacation package generated by the vacation packaging engine based on at least one user-selected vacation topic and displays the at least one vacation package via at least one user interface communicatively coupled to the processor;
an opaque pricing module, executed by the processor, wherein the opaque pricing module generates a bundled vacation package price by concealing at least one individual pricing component, wherein the bundled vacation package price dynamically adjusts based on a revenue management rule, a user engagement metric, and a demand-based pricing variable; and
a multifactorial AI decision support algorithm, executed by the processor, wherein the multifactorial AI decision support algorithm analyzes at least one user interaction to modify vacation package recommendations in real time.

2. The system of claim 1, further comprising a blockchain-based transaction module, wherein the blockchain-based transaction module stores at least one booking confirmation and at least one pricing adjustment in a decentralized ledger, ensuring secure recordkeeping and transaction verification.

3. The system of claim 2, wherein the blockchain-based transaction module is configured to record all transaction details to a decentralized ledger using at least one consensus validation mechanism.

4. The system of claim 3, wherein the blockchain-based transaction module executes at least one smart contract automation process to ensure automatic refund processing in case of pricing inconsistencies.

5. The system of claim 4, further comprising a real-time package availability and/or pricing module, wherein the real-time package availability and pricing module retrieves Availability, Rates, and Inventory (ARI) data and verifies the real-time pricing of at least one vacation package component prior to booking.

6. The system of claim 5, further comprising an Application Programming Interface (API) configured to facilitate external communication between the vacation packaging engine and at least one third-party service provider, ensuring real-time data synchronization.

7. The system of claim 6, further comprising a booking engine, wherein the booking engine is configured to finalize the at least one transaction of the vacation package based on real-time pricing verification and updates an acceptance module to confirm the successful booking.

8. The system of claim 6, wherein the popup packaging widget module retrieves at least one vacation topic from the vacation packaging engine via the API-based data exchange.

9. The system of claim 8, wherein the popup packaging widget module dynamically updates vacation package recommendations using the AI-based personalization engine trained on at least one behavioral clustering algorithm.

10. The system of claim 1, wherein the AI-based personalization engine continuously refines at least one user preference model using deep learning-based predictive analytics.

11. The system of claim 10, wherein the AI-based personalization engine integrates collaborative filtering algorithms to identify vacation packages preferred by similar user segments.

12. A method for structuring at least one vacation package, the method comprising:
retrieving at least one vacation topic via a vacation topics import engine, executed by a processor of a vacation packaging configurator;
generating at least one vacation package recommendation from the at least one retrieved vacation topic using at least one multifactorial AI decision support algorithm, executed by the processor, wherein the at least one multifactorial AI decision support algorithm executes at least one machine-learning-based engagement model to analyze at least one preference profile of the at least one user in conjunction with the at least one retrieved vacation topic;
applying an opaque pricing module of the vacation packaging configurator to determine a bundled vacation package price, wherein the opaque pricing module conceals at least one individual pricing component; and
dynamically modifying at least one vacation package component based on a real-time package availability and pricing module, executed by the processor, wherein the real-time package availability and pricing module retrieves at least one ARI data set and cross-references an API from at least one third-party service provider.

13. The method of claim 12, further comprising the step of, finalizing a structured vacation package and transmitting at least one structured vacation package confirmation via at least one acceptance module.

14. The method of claim 13, further comprising the step of, storing a vacation package structuring record in a blockchain-based transaction module, wherein the blockchain-based transaction module ensures pricing integrity and transaction immutability.

15. The method of claim 14, wherein the popup packaging widget module optimizes upsell recommendations by utilizing at least one predictive conversion model based on past user interactions.

16. A method for booking at least one vacation package, the method comprising:
receiving at least one vacation package selection via a popup packaging widget module executed on a processor communicatively coupled to a vacation packaging configurator;
retrieving real-time ARI data via a real-time package availability and pricing module of the vacation packaging configurator, wherein the real-time package availability and pricing module confirms the availability and cost of at least one vacation package component;
comparing the vacation package price with the real-time ARI data retrieved by the real-time package availability and pricing module to determine whether the stated vacation package price is consistent with the latest real-time pricing data;
dynamically modifying the bundled vacation package price, via an opaque pricing module executed by the processor, if the stated vacation package price does not match the real-time ARI data, wherein the opaque pricing module adjusts the price using at least one at least one multifactorial AI decision support algorithm to recalculate the bundled package rate based on predefined revenue management rules; and
transmitting at least one structured travel itinerary to at least one user interface communicatively coupled to the vacation packaging configurator, wherein the structured travel itinerary includes real-time pricing adjustments and automated refund processing data if a pricing inconsistency is detected.

17. The method of claim 16, further comprising the step of, processing the vacation package transaction using a blockchain-based transaction module communicatively coupled to the vacation packaging configurator, wherein the blockchain-based transaction module executes at least one smart contract validation mechanism to confirm at least one booking term and ensure transaction integrity.

18. The method of claim 17, further comprising the step of, finalizing the at least one vacation package booking via a booking engine of the vacation packaging configurator, wherein the booking engine updates an acceptance module to confirm the booking.

19. The method of claim 16, wherein the at least one multifactorial AI decision support algorithm optimizes vacation package suggestions using at least one reinforcement learning model trained on past user engagement metrics.

20. The method of claim 16, wherein the opaque pricing module retrieves real-time competitor pricing data from at least one API-based pricing analysis service to ensure competitive rate associated with the vacation package.
